(19) United States
(12) Patent Application Publication
(10) Pub. No.: US 2002/0026481 A1
(43) Pub. Date: Feb. 28, 2002

(54) Electronic mail system and electronic mail delivery method

(76) Inventors: Masaaki Mori, Kanagawa (JP); Yasutaka Oda, Kanagawa (JP); Masao Tomofuji, Kanagawa (JP); Masaya Kimura, Kanagawa (JP); Eiji Ujyo, Kanagawa (JP); Mihoko Kawahara, Kanagawa (JP)

Correspondence Address: STAAS & HALSEY LLP, 700 11TH STREET, NW, SUITE 500, WASHINGTON, DC, 20001, US

(21) Appl. No.: 09/804,249

(22) Filed: Mar. 13, 2001

(30) Foreign Application Priority Data
Aug. 30, 2000 (JP) 2000-260097

(51) Int. Cl. G06F 15/16

(52) U.S. Cl. 709/206; 709/207

(57) ABSTRACT

An electronic mail system that is used to send electronic mail with an attached file reliably regardless of the status of mail servers on a transmission path. In this electronic mail system, if an attached file is added to electronic mail sent from a mail client, being a sender, an attached file separating section separates the attached file from the electronic mail. An attached file transferring section transfers the attached file separated from the electronic mail by the attached file separating section to an FTP server. A store location information adding section adds store location information indicating a location where the attached file transferred by the attached file transferring section is stored to the electronic mail. The electronic mail to which the store location information has been added is sent to a receiver mail server. A mail client can refer to the received mail by accessing the mail server and download the attached file from the FTP server by referring to the store location information added to the mail.

### BACKGROUND OF THE INVENTION

(1) Field of the Invention

This invention relates to an electronic mail system and, more particularly, to an electronic mail system for delivering electronic mail sent from a sender to the appropriate receiver.

(2) Description of the Related Art

With the spread of Internet and local area networks (LAN), various documents have come to be exchanged routinely through networks. In general, electronic mail is used because of the simplicity of its operation.

There are various types of electronic mail. They include electronic mail based on original standards, such as MS-Mail (trademark) and Exchange (trademark) developed by Microsoft Corp. and cc:Mail (trademark) and Notes (trademark) developed by Lotus Development Corp., electronic mail conforming to the message oriented text interchange system (MOTIS) defined in X.400 of the ITU-T Recommendation, and electronic mail usually used on Internet (Internet mail).

These types of electronic mail adopt the multipurpose Internet mail extensions (MIME), being an extended standard of text mail, in response to the need for sending not only text but also multimedia data contents, such as documents, speech, and images, created by a word processor etc. In MIME a label for designating a data type is introduced, so various pieces of data can be attached. As a result, mail with an attached file can be transferred by the simple operation of attaching the file to the mail. Data attached to electronic mail is hereinafter referred to as an “attached file”.

When mail is transferred via Internet, it usually goes through a plurality of mail servers. Therefore, if a shortage of storage capacity has occurred in an external memory for any of these relay mail servers or if the capacity of a network between relay mail servers is small, mail may not be transferred properly.

### SUMMARY OF THE INVENTION

In order to address such a problem, the present invention was made. In other words, an object of the present invention is to provide an electronic mail system and an electronic mail delivery method that can deliver electronic mail with an attached file reliably regardless of the status of relay mail servers in the case of the electronic mail being transferred via Internet.

In order to achieve the above object, an electronic mail system for delivering electronic mail sent from a sender to the appropriate receiver is provided. This electronic mail system comprises attached file separating means for separating, in the case of an attached file being added to electronic mail sent from the sender, the attached file from the electronic mail, attached file transferring means for transferring the attached file separated from the electronic mail by the attached file separating means to a predetermined server, and store location information adding means for adding store location information indicating a location where the attached file transferred by the attached file transferring means is stored to the electronic mail.

Moreover, in order to achieve another object of the present invention, an electronic mail delivery method for delivering electronic mail sent from a sender to the appropriate receiver is provided. This electronic mail delivery method comprises an attached file separating step for separating, in the case of an attached file being added to electronic mail sent from the sender, the attached file from the electronic mail, an attached file transferring step for transferring the attached file separated from the electronic mail by the attached file separating step to a predetermined server, and a store location information adding step for adding store location information indicating a location where the attached file transferred by the attached file transferring step is stored to the electronic mail.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a view for describing the operating principle of the present invention.

FIG. 2 is a view showing the entire configuration of a system according to an embodiment of the present invention.

FIG. 3 is a view showing in detail the configuration of a computer 101 shown in FIG. 2.

FIG. 4 is a view showing in detail the configuration of a computer 103 shown in FIG. 2.

FIG. 5 is a view showing in detail electronic mail with an attached file.

FIGS. 6(A), 6(B), and 6(C) are views each showing an example of a sender transfer management information table.

FIG. 7 is a view showing an example of a definition for sender transfer management information.

FIG. 8 is a view showing an example of electronic mail to which store location information has been added in a sender mail mediating apparatus.

FIG. 9 is a view showing an example of a mail mediating apparatus list information table.

FIGS. 10(A), 10(B), and 10(C) are views each showing an example of a receiver transfer management information table.

FIG. 11 is a view showing an example of a definition for receiver transfer management information.

FIG. 12 is a view showing an example of electronic mail to which store location information has been added in a receiver mail mediating apparatus.

FIG. 13 is a view showing a data sequence in a first embodiment of the present invention.

FIG. 14 is a flow chart for describing an example of processes performed in a mail mediating apparatus 151 shown in FIG. 2.

FIG. 15 is a flow chart for describing an example of processes performed in a mail mediating apparatus 152 shown in FIG. 2.

FIG. 16 is a view showing the configuration of the computer 101 in a second embodiment of the present invention.

FIG. 17 is a view showing the configuration of the computer 103 in the second embodiment of the present invention.

FIG. 18 is a view showing an example of electronic mail with an attached file.

FIG. 19 is a view showing an example of a mail mediating apparatus list information table.

FIG. 20 is a view showing an example of electronic mail from which a file has been separated in a sender mail mediating apparatus.

FIG. 21 is a view showing an example of electronic mail to which store location information has been added in a sender mail mediating apparatus.

FIG. 22 is a view showing the configuration of the computer 101 in a third embodiment of the present invention.

FIG. 23 is a view showing the configuration of the computer 103 in the third embodiment of the present invention.

FIG. 24 is a view for giving an overview of the operation of a sender mail mediating apparatus.

FIG. 25 is a view for giving an overview of the operation of a receiver mail mediating apparatus.

FIG. 26 is a view showing a data sequence in the third embodiment of the present invention.

FIG. 27 is a view showing a data sequence in the third embodiment of the present invention.

FIG. 28 is a flow chart for describing an example of processes performed in the mail mediating apparatus 151 in the third embodiment of the present invention.

FIG. 29 is a flow chart for describing an example of processes performed in the mail mediating apparatus 152 in the third embodiment of the present invention.

FIG. 30 is a view showing the entire configuration of a system according to a fourth embodiment of the present invention.

FIG. 31 is a view showing in detail the configuration of a computer 481 shown in FIG. 30.

FIG. 32 is a view for giving an overview of the operation of a relay mail mediating apparatus.

FIG. 33 is a view showing a signal flow in the fourth embodiment of the present invention.

FIG. 34 is a flow chart for describing an example of processes performed in a mail mediating apparatus 451 shown in FIG. 30.

FIG. 35 is a view showing an example of a secondary memory configured by LDAP.

FIG. 36 is a view showing an example of a secondary memory configured by LDAP.

FIG. 37 is a view showing an example of a secondary memory configured by ODBC.

FIG. 38 is a view showing an example of a secondary memory configured by ODBC.

### DESCRIPTION OF THE PREFERRED EMBODIMENTS

Embodiments of the present invention will now be described with reference to the drawings.

A “receiver mail server” in this specification is the one used as a simple mail transfer protocol (SMTP) server on Internet. sendmail (trademark) and qmail (trademark) for UNIX (trademark), IMAIL Server (trademark) for Windows NT (trademark), etc. are generally known as SMTP servers. Examples in this specification will be described with sendmail (trademark) as an SMTP server. An exit from sendmail (trademark) is described in detail in paragraph 3.2, “Role of Local Delivery” (p. 30) and paragraph 6.2, “Define a Mail Delivery Agent” (p. 66) in “sendmail System Management” (Bryan Costales and Eric Allman, O'REILLY Japan). An SMTP gateway etc. for cooperating with an original-standard mail system, such as Exchange (trademark) developed by Microsoft Corp. or Notes (trademark) developed by Lotus Development Corp., are also SMTP servers. A secondary memory control device and secondary memory are what people call a way and device to manage directories. openldap, Netscape Directory Server (trademark), etc. which support the lightweight directory access protocol (LDAP) are typical of them.

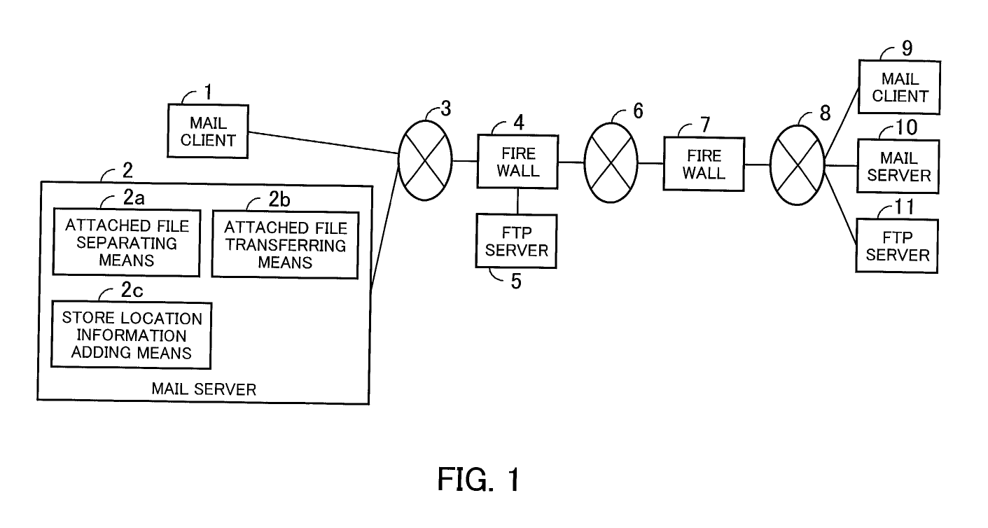

FIG. 1 is a view for describing the operating principle of the present invention. In FIG. 1, a mail client 1 sends mail created by a user.

A mail server 2 comprises attached file separating means 2a, attached file transferring means 2b, and store location information adding means 2c. The mail server 2 receives mail sent from the mail client 1, separates, in the case of an attached file being added to the mail, the attached file from the mail, stores the attached file in a predetermined server, and sends the mail from which the attached file has been separated to a receiver mail server.

If an attached file is added to electronic mail sent from the sender mail client 1, the attached file separating means 2a separates the attached file from the electronic mail.

The attached file transferring means 2b transfers the attached file separated from the electronic mail by the attached file separating means 2a to a predetermined server.

The store location information adding means 2c adds store location information indicating a location where the attached file transferred by the attached file transferring means 2b is stored to the electronic mail.

A network 3 consists of, for example, LAN.

A fire wall 4 prevents a malicious user from intruding into the network 3.

A file transfer protocol (FTP) server 5 transfers a file in compliance with FTP, being a protocol for exchanging files between computers connected to Internet.

A network 6 consists of, for example, Internet.

A fire wall 7 prevents a malicious user from intruding into the network 8. This is the same with the fire wall 4.

A network 8 consists of, for example, LAN.

A mail client 9 receives mail sent.

A mail server 10 sends mail to and receives mail from the mail server 2 in compliance with the simple mail transfer protocol (SMTP). Furthermore, when the mail client 9 accesses the mail server 10, it passes the mail client 9 mail which arrived in compliance with the post office protocol (POP) etc.

An FTP server 11 transfers a file in compliance with FTP, being a protocol for exchanging files between computers connected to Internet. This is the same with the FTP server 5.

Now, operation in FIG. 1 will be described.

It is assumed that a user of the mail client 1 created mail with an attached file and that he/she sent it to the mail client 9.

The mail sent from the mail client 1 is passed to the mail server 2. The attached file separating means 2a in the mail server 2 separates the attached file from the mail which the mail server 2 received, and provides it to the attached file transferring means 2b.

The attached file transferring means 2b transfers the attached file to the predetermined FTP server 5 and has the FTP server 5 store it in a predetermined area.

The store location information adding means 2c adds store location information indicating a predetermined area on the FTP server 5 where the attached file is stored to the mail from which the attached file has been separated. This mail is sent to the mail server 10 via, for example, the network 3, which is the same with ordinary mail.

In such a state, it is assumed that a user of the mail client 9 performed operations to receive mail. Then the mail server 10 will pass the mail client 9 mail it received.

The user of the mail client 9 can read the contents of the mail passed to the mail client 9 by causing it to be displayed on the screen. In addition, he/she can transfer an attached file from the FTP server 5 to the FTP server 11 by the use of store location information added to the mail and download it from the FTP server 11 with a browser installed on the mail client 9. By doing so, he/she can read its contents. In this case, a file transfer between the FTP servers 5 and 11 is performed in compliance with FTP suitable for it and the file is transferred separately from the mail. Therefore, even if there remains little free space on a secondary memory for a server which the mail goes through, the attached file and mail can be transferred reliably.

As stated above, in an electronic mail system according to the present invention, an attached file is separated from mail and is stored in a predetermined resource on a network and the mail to which information indicating the store location is added is sent. This enables the mail and attached file to be transmitted via different routes, at different times, or in compliance with different protocols. As a result, the mail and attached file can be transmitted to a receiver reliably regardless of the state of a transmission route.

Now, a first embodiment of the present invention will be described.

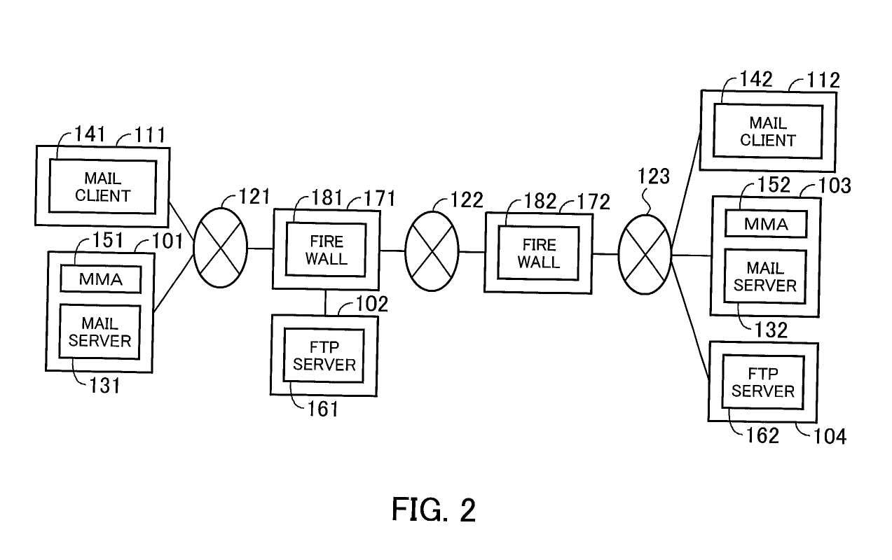

FIG. 2 is a view showing the configuration of an embodiment of the present invention. In this embodiment, two mail mediating apparatus are implemented as exit programs on a sender and receiver mail server respectively, and are started when these servers receive mail.

In FIG. 2, a mail client 141 is implemented in a computer 111, so mail can be sent or received.

A mail mediating apparatus (MMA) 151 and mail server 131 are implemented in a computer 101. The mail server 131 sends or receives mail and the mail mediating apparatus 151 sends or receives an attached file separately from mail to which it is added.

A LAN 121 consists of, for example, a network spread across a company, connects the computers 111, 101, etc. mutually, and sends information to or receives information from the outside.

A fire wall 181 is implemented in a computer 171. The fire wall 181 located between the LAN 121 and Internet 122 permits only particular data to go through it in order to prevent a malicious user from intruding into the LAN 121.

An FTP server 161 is implemented in a computer 102. The FTP server 161 stores an attached file provided from the mail mediating apparatus 151 and transfers an attached file to an FTP server 162 in compliance with FTP.

The Internet 122 is an aggregate of countless servers dispersed throughout the world and can send or receive various pieces of information.

A fire wall 182 is implemented in a computer 172. The fire wall 182 located between a LAN 123 and the Internet 122 permits only particular data and protocols to go through it in order to prevent a malicious user from intruding into the LAN 123.

The LAN 123 consists of, for example, a network spread across a company, connects computers 112, 103, 104, etc. mutually, and sends information to or receives information from the outside.

A mail client 142 is implemented in a computer 112, so mail can be sent or received.

A mail mediating apparatus (MMA) 152 and mail server 132 are implemented in a computer 103. The mail server 132 sends or receives mail and the mail mediating apparatus 152 sends or receives an attached file separately from mail to which it is added. This is the same with the computer 101.

An FTP server 162 is implemented in a computer 104. The FTP server 162 stores an attached file provided from the computer 102 and provides an attached file it stores to the mail client 142.

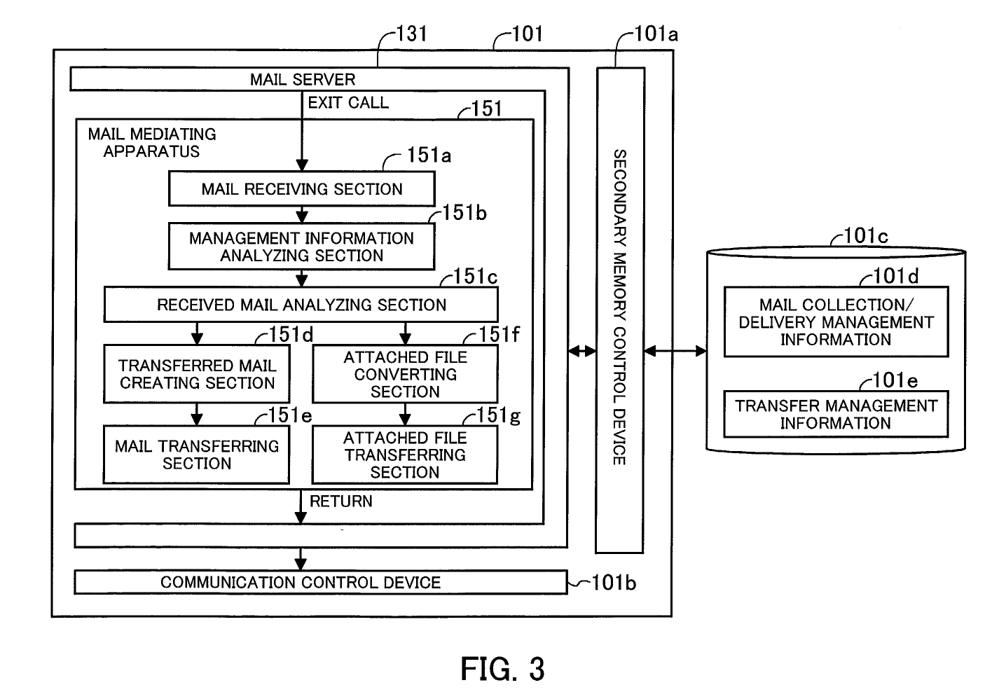

The configuration of the computer 101 will now be described in detail with reference to FIG. 3.

The computer 101 comprises the mail server 131, the mail mediating apparatus 151, a secondary memory control device 101a, and a communication control device 101b. Furthermore, a secondary memory 101c is connected externally to the computer 101.

The mail server 131 sends mail to or receives mail from another mail server in compliance with SMTP and passes a user mail it received in compliance with POP.

The mail mediating apparatus 151 comprises a mail receiving section 151a, a management information analyzing section 151b, a received mail analyzing section 151c, a transferred mail creating section 151d, a mail transferring section 151e, an attached file converting section 151f, and an attached file transferring section 151g and performs a process on mail to which an attached file is added.

To be concrete, the mail receiving section 151a receives mail from the mail server 131. The management information analyzing section 151b analyzes transfer management information 101e read via the secondary memory control device 101a and stores the results in a temporary memory (not shown).

The received mail analyzing section 151c analyzes the mail received. If a file is attached to the received mail analyzed, the attached file converting section 151f separates the attached file from the received mail and stores the attached file in the secondary memory 101c as an intermediate file for a time.

The attached file transferring section 151g transfers the attached file separated from the received mail to an FTP server described as a destination in the transfer management information 101e stored in the temporary memory. The transferred mail creating section 151d re-creates new mail in order to deliver the received mail from which the attached file has been separated to its original receiver, and sets store location information indicating an FTP server where the attached file is stored in a mail header. The mail transferring section 151e delivers the mail created to the original receiver.

The secondary memory control device 101a controls the secondary memory 101c externally connected in order to read out necessary information and to write given information to a predetermined area.

The communication control device 101b exerts control necessary for communicating with other devices via the LAN 121.

The secondary memory 101c stores mail collection/delivery management information 101d which the mail server 131 uses to collect or deliver mail and the transfer management information 101e indicating the destination of an attached file.

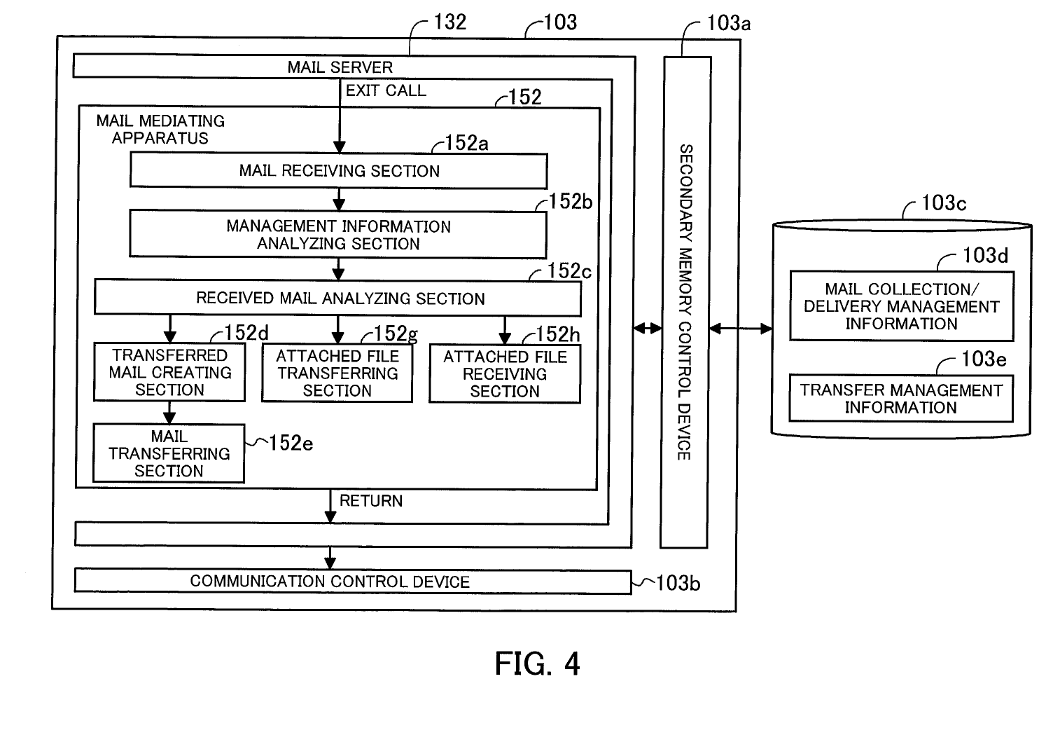

The configuration of the computer 103 will now be described in detail with reference to FIG. 4.

As with the computer 101, the computer 103 comprises the mail server 132, the mail mediating apparatus 152, a secondary memory control device 103a, and a communication control device 103b. Furthermore, a secondary memory 103c is connected externally to the computer 103.

The computer 101 shown in FIG. 3 and the computer 103 are the same except part of the configuration of the mail mediating apparatus 152. The differences between them therefore will now be described.

If analysis by a received mail analyzing section 152c showed that a file was attached to received mail, an attached file receiving section 152h receives the attached file from the appropriate FTP server on the basis of store location information regarding the attached file set in the header of the received mail and saves it in the secondary memory 103c for a time.

An attached file transferring section 152g transfers the attached file separated from the received mail or received to a destination described in the transfer management information 103e stored in a temporary memory.

A transferred mail creating section 152d recreates new mail in order to deliver the received mail to its original receiver. Then a mail transferring section 152e transfers the new mail created to the receiver.

Now, operation in the above embodiment will be described. In this embodiment, mail with an attached file is sent from the computer 111 and the attached file is separated from the mail proper on the computer 101. The mail proper is transferred to the computer 103 via an ordinary route. The attached file is stored on the computer 102 for a time, then is transferred to the computer 104, and then is sent to the computer 112. This operation will now be described in detail.

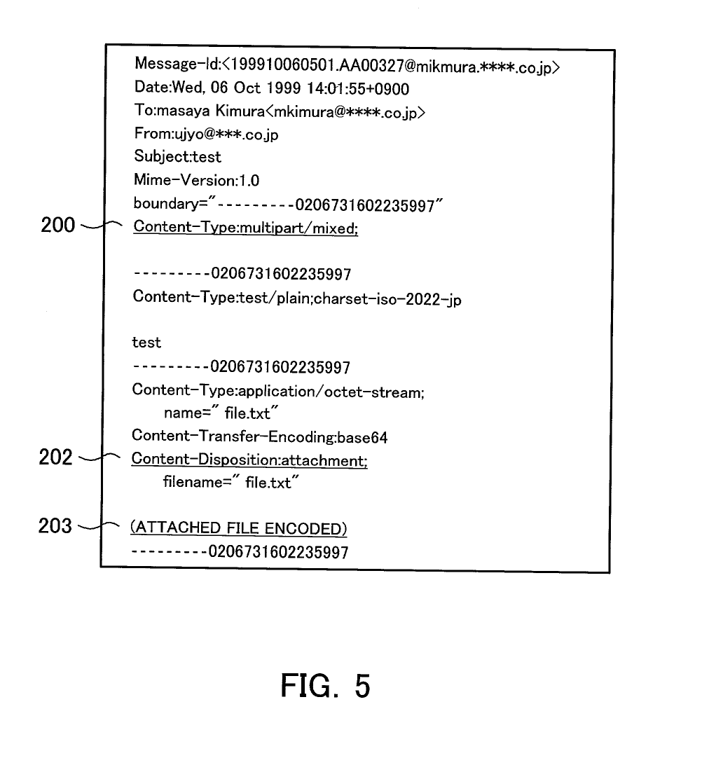

It is assumed that a user of the computer 111 sent a user of the computer 112 mail with an attached file, for example, shown in FIG. 5. In the example shown in FIG. 5, an attached file encoded in compliance with MIME 203 is added.

If Content-Type (200) is “multipart/mixed” and Content-Disposition (202) for mail proper is “attachment,” then a file will be attached to the mail. The receiver of this mail is “mkimura@****.co.jp” described after “To:”. Its sender is “ujyo@***.co.jp” described after “From:”.

Such mail is sent to the mail server 131 in the computer 101 by the mail client 141 in the computer 111.

The mail server 131 which received the mail with an attached file relays it to the mail mediating apparatus 151. It is assumed that the mail client and mail server conform to the operation of an Internet electronic mail system.

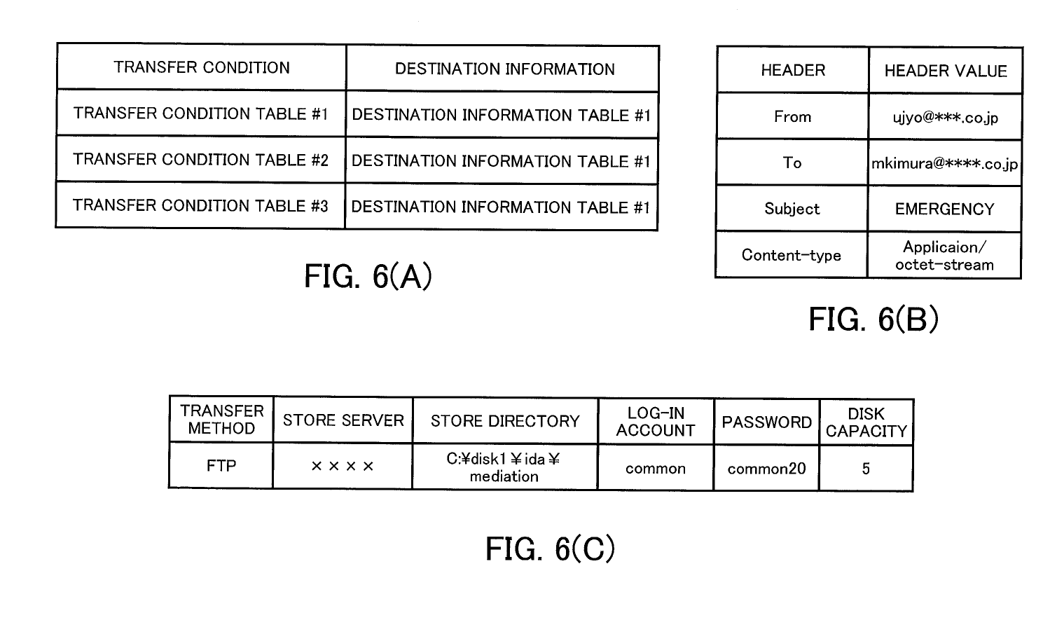

A mail administrator has registered in advance transfer management information, for example, shown in FIGS. 6(A), 6(B), and 6(C) with the secondary memory 101c for the mail mediating apparatus 151. In the example shown in FIGS. 6(A), 6(B), and 6(C), transfer conditions and destinations are associated and stored. An objective destination can be specified by finding which destination matches information included in the header of the mail.

For example, if the sender's mail address, the receiver's mail address, the subject, and the type of information (Content-Type) are “ujyo@***.co.jp,” “mkimura@****.co.jp,” “Emergency,” and “Application/octet-stream” respectively; then a transfer method, a store server, a store directory, a log-in account, a password, and disk capacity are specified as “FTP,” “xxxx,” “C:disk1¥ida¥mediation,” “common,” “common20,” and “5” respectively.

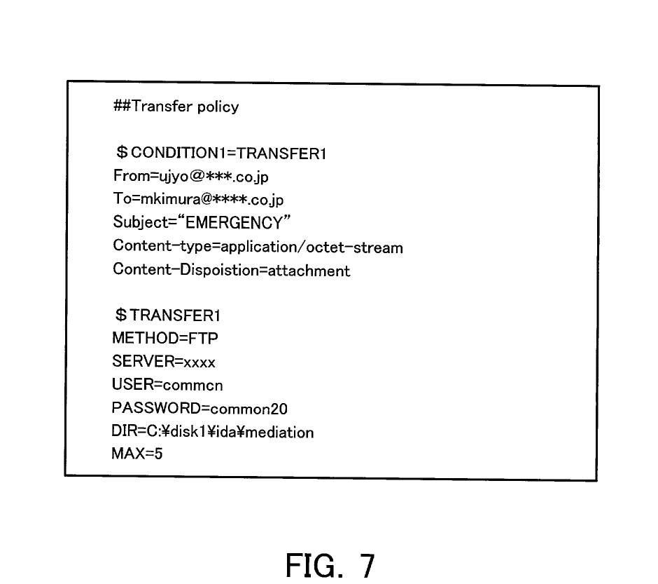

The mail receiving section 151a which received the mail writes the transfer management information 101e from the secondary memory 101c to the temporary memory. Then the transfer management information 101e is analyzed and is stored again in the temporary memory in a form shown in FIG. 7. In an example shown in FIG. 7, transfer conditions are enumerated.

The received mail analyzing section 151c to which control is passed judges whether or not a file is attached to the received mail. As stated above, whether Content-Type is “multipart/mixed” and Content-Disposition for the mail proper is “attachment” is a criterion for this judgement. If the received mail analyzing section 151c judges that an attached file is added, it calls the attached file converting section 151f.

The attached file converting section 151f converts the attached file encoded 203 shown in FIG. 5 to the original binary format and stores the converted file in the secondary memory 101c. Furthermore, the attached file converting section 151f removes the attached file from the received mail.

The attached file transferring section 151g transfers the attached file stored in the secondary memory 101c to a location designated as a destination on the basis of the transfer management information 101e stored in the temporary memory. In this embodiment, the attached file is transferred to the computer 102 in compliance with FTP by the use of a user account and password indicated in the transfer management information 101e.

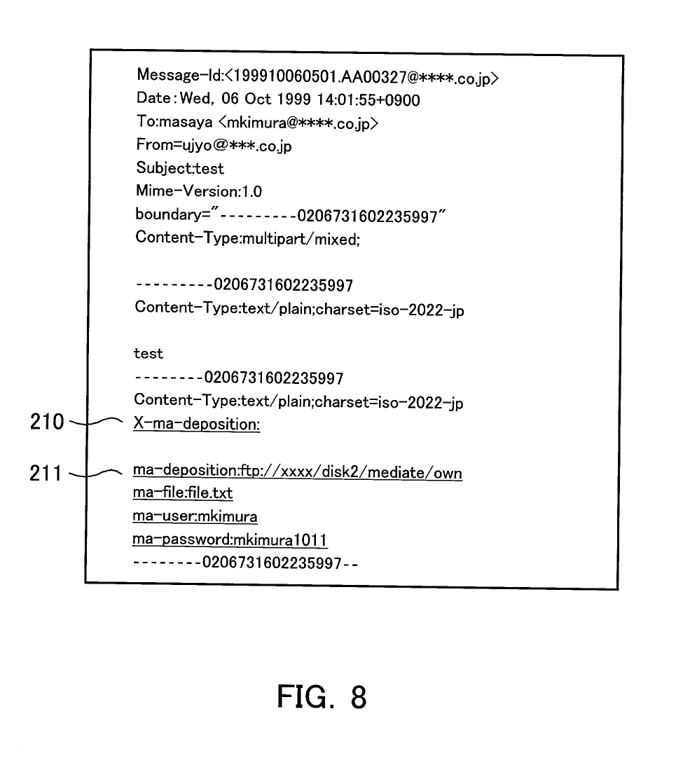

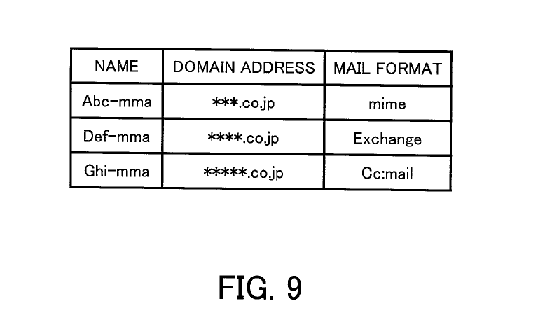

The transferred mail creating section 151d sets a store server, store directory, log-in account, and password, being store location information, included in the transfer management information 101e in an extended mail header. As a result, new mail, for example, shown in FIG. 8 will be created. In this example, information regarding a location where the attached file is stored is added to the end of the mail, as shown in 210 and 211. In this case, another mail format may be used at the destination. Therefore, in order to cope with such a case, a table like the one shown in FIG. 9 which associates servers with mail formats can be stored in advance in the secondary memory 101c and a mail format can be converted at need.

The mail transferring section 151e transfers the received mail converted to the original destination. This mail transfer process is the same as a mail sending process performed generally by a mail server on Internet.

The mail server 132 in the computer 103 receives the above mail sent from the computer 101. The operation of the mail server 132 is the same with an Internet electronic mail system.

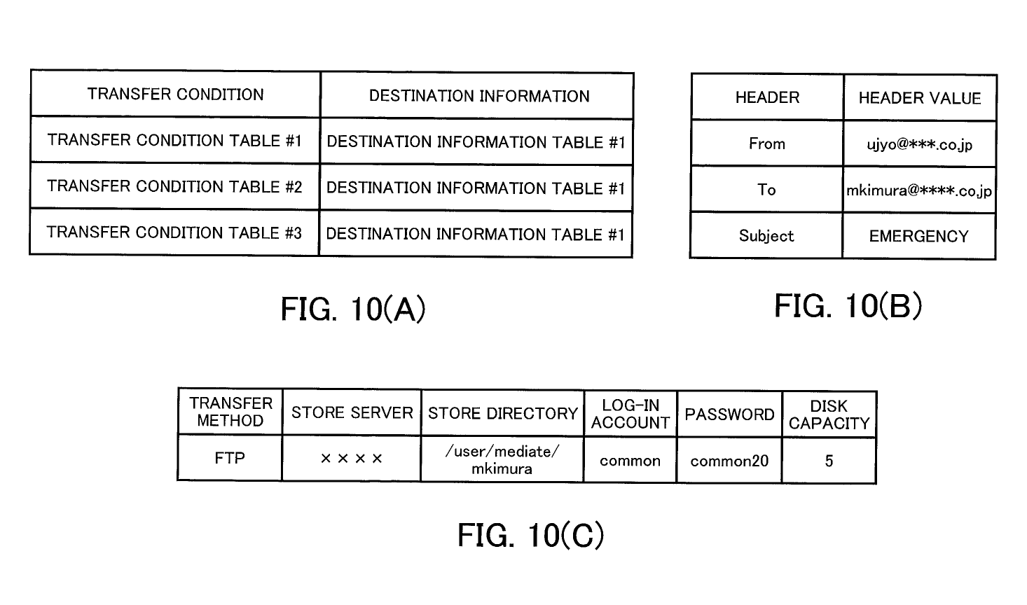

Then a mail receiving section 152a in the mail mediating apparatus 152 receives the mail converted on the sender side (see FIG. 8). The transfer management information 103e is registered in advance with the secondary memory 103c by a mail user. FIGS. 10(A), 10(B), and 10(C) are views each showing an example of the transfer management information 103e registered in this embodiment. In these examples, if a file is attached to the received mail, the FTP server “ftp://xxxx/user/mediate/mkimura” is registered as a location where a file attached to mail sent to the user's mail address (mkimura@****.co.jp) is stored.

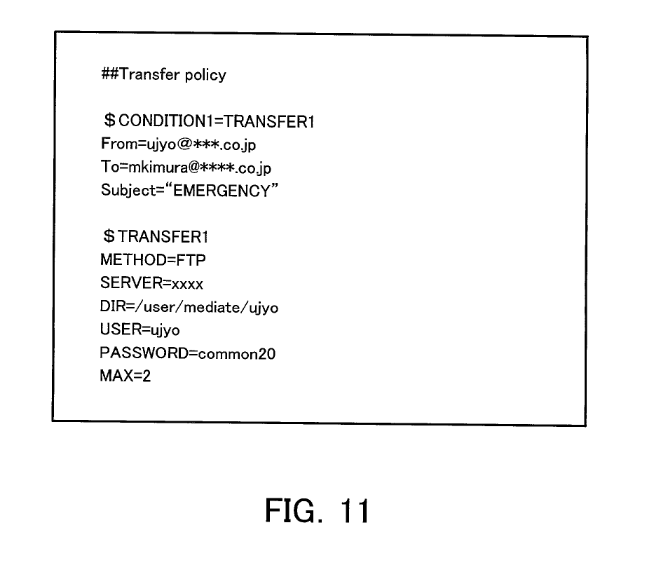

The mail receiving section 152a which received the mail writes the transfer management information 103e from the secondary memory 103c to a temporary memory. Then the transfer management information 103e is analyzed and the results are stored again in the temporary memory in a format shown in FIG. 11.

The received mail analyzing section 152c judges whether or not an extended header and store location information set by the mail mediating apparatus for the sender mail server described above are included in the header portion of the received mail shown in FIG. 8. If they are included, then the received mail analyzing section 152c calls the attached file receiving section 152h.

The attached file receiving section 152h called receives an attached file from the FTP server 161 by the use of a store server name, store directory, user account, and password, being the store location information, and the extended header and stores it in the secondary memory 103c for a time.

The received mail with an extended header and store location information not set did not go through the mail mediating apparatus 151 for the sender mail server 131. In that case, whether or not a file is attached to the received mail is judged. This analysis conforms to the provisions for the Internet-standard format for mail with an attached file (MIME).

The received mail analyzing section 152c converts the attached file to the original binary format and stores the converted file in the secondary memory 103c. Furthermore, the received mail analyzing section 152c removes the attached file portion (portion corresponding to 211 in FIG. 8) from the received mail. This is the same with the mail mediating apparatus 151 for the sender mail server 131.

The attached file transferring section 152g transfers the attached file stored in the secondary memory 103c in this way to a server designated in the store location information by referring to the transfer management information 103e stored in the temporary memory.

In this example, the attached file is transferred to the FTP server 162 in the computer 104 by the use of a user account and password included in the transfer management information 103e.

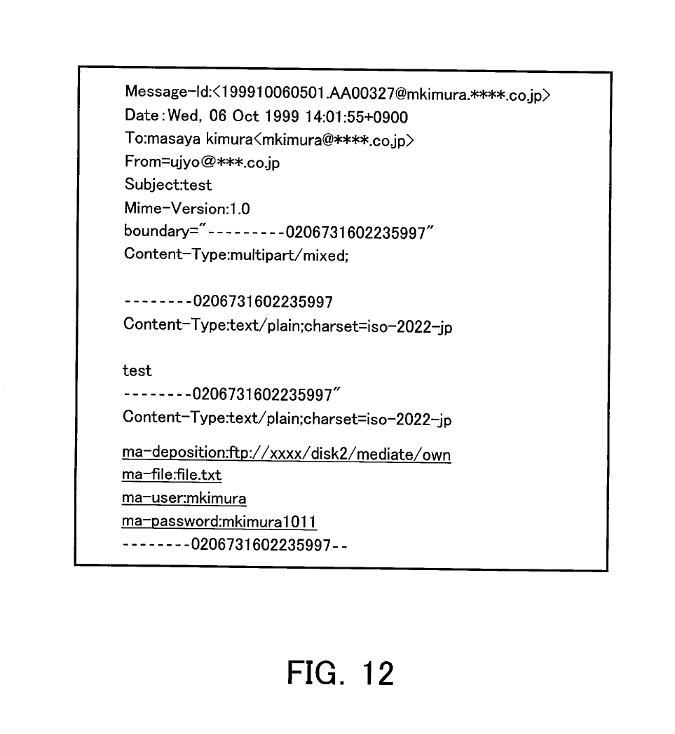

The transferred mail creating section 152d sets a store server, store directory, log-in account, and password, being transfer management information, in the mail body as store location information. As a result, the received mail will be converted, as shown in FIG. 12.

The mail transferring section 152e delivers the received mail converted to the original receiver's mail box. This mail delivery process is generally the same as a local delivery process performed by a mail server on Internet. As a result of referring to the transfer management information 103e stored in the temporary memory, the receiver mail server may prove not to support a mail format currently used. In that case, the format of the received mail is converted to the one the receiver mail server supports, then it is transferred. Unless otherwise described, the received mail will be transferred with its format maintained.

The mail client 142 in the computer 112 receives the mail without the attached file delivered in this way to the mail box on the mail server in the computer 103. A user knows the store server, store directory, log-in account, and password, being the transfer management information 103e, as store location information from the mail body. He/she can refer to the attached file by logging in the FTP server 162 by the use of these pieces of information.

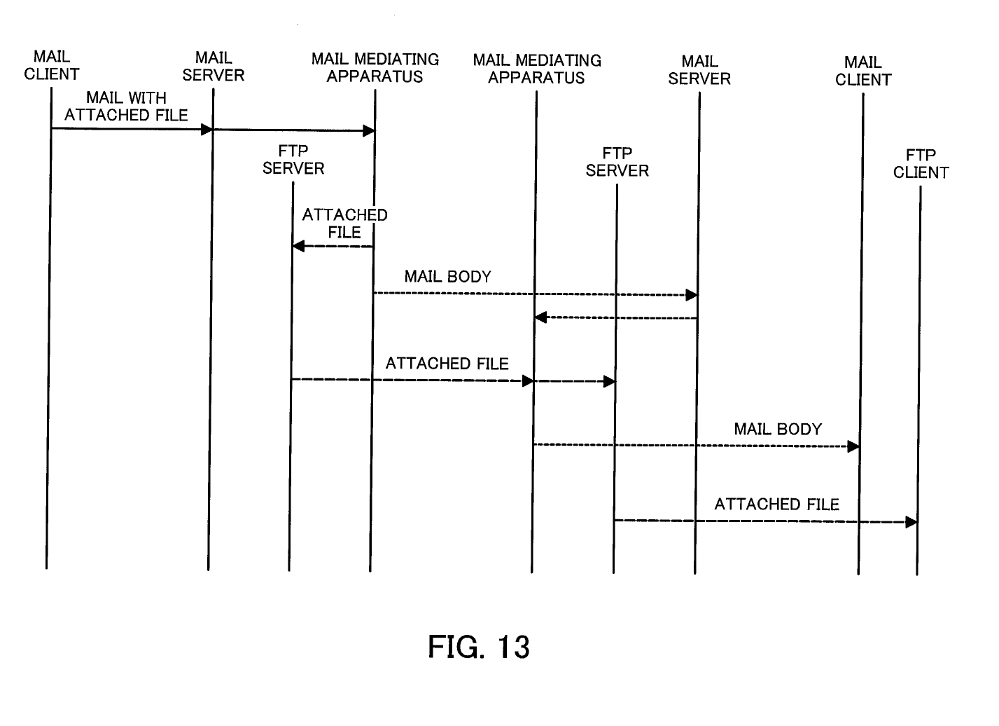

FIG. 13 shows the flow of the above processes. In FIG. 13, a solid, broken, and dotted line indicate mail with an attached file, an attached file, and a mail body respectively. Now, FIG. 13 will be described in brief. Mail with an attached file sent from the mail client 141 is delivered to the mail mediating apparatus (MMA) 151 via the mail server 131. In the mail mediating apparatus 151, the attached file is separated from the mail body and is transferred to the FTP server 161 and the mail body is transferred to the mail server 132. When a user on the receiver side performs operation to receive mail, the mail body is delivered from the mail server 132 to the mail client 142 via the mail mediating apparatus 152. On the other hand, the attached file is transferred from the FTP server 161 to the FTP server 162 via the mail mediating apparatus 152 and is delivered from the FTP server 162 to the computer 112 at the user's instruction.

As described above, in the first embodiment of the present invention, mail and a file attached to it are sent at different times, via different routes, and by different methods. This enables an attached file to be sent reliably regardless of the status of communication lines etc. the mail goes through.

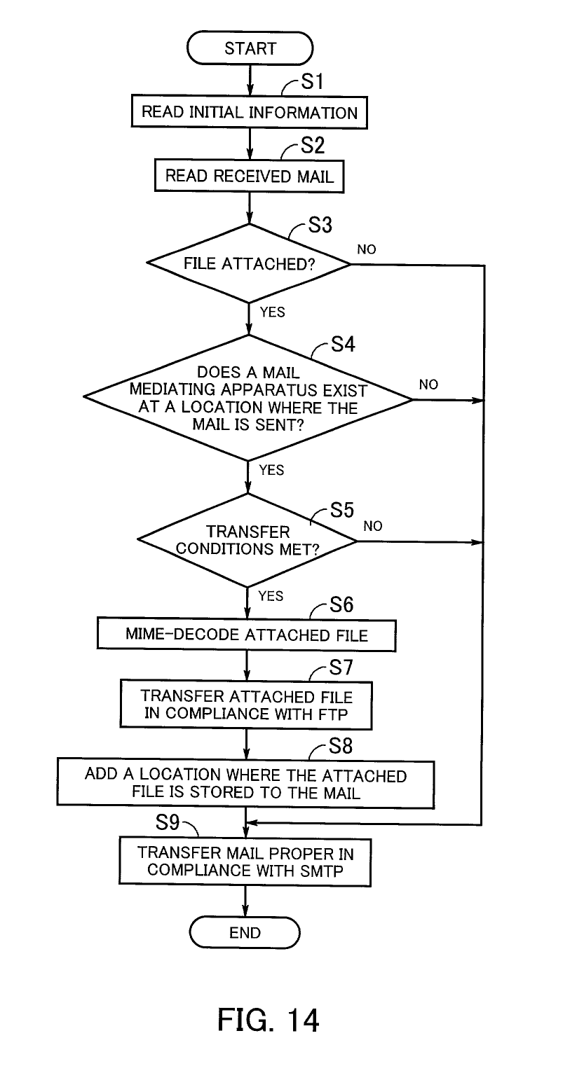

Now, an example of processes performed in the mail mediating apparatus 151 shown in FIG. 2 will be described with reference to FIG. 14. The following procedure will be performed in compliance with this flow chart.

[S1] The mail mediating apparatus 151 reads mail mediating apparatus list information and the transfer management information 101e as the initial information from the secondary memory 101c, converts the mail mediating apparatus list information to the table shown in FIG. 9, and converts the transfer management information 101e to the tables shown in FIGS. 6(A), 6(B), and 6(C).

[S2] The mail mediating apparatus 151 reads received mail.

[S3] The mail mediating apparatus 151 judges whether or not a file is attached to the received mail. If a file is attached, the mail mediating apparatus 151 proceeds to step S4. If a file is not attached, the mail mediating apparatus 151 proceeds to step S9.

[S4] The mail mediating apparatus 151 judges by referring to the table shown in FIG. 9 whether or not a mail mediating apparatus exists at a location where the mail is sent. If a mail mediating apparatus exists, the mail mediating apparatus 151 proceeds to step S5. If a mail mediating apparatus does not exist, the mail mediating apparatus 151 proceeds to step S9.

[S5] The mail mediating apparatus 151 judges whether or not the mail meets transfer conditions. If it meets the transfer conditions, the mail mediating apparatus 151 proceeds to step S6. If it does not meet the transfer conditions, the mail mediating apparatus 151 proceeds to step S9.

[S6] The mail mediating apparatus 151 decodes the attached file in compliance with MIME.

[S7] The mail mediating apparatus 151 transfers the attached file to an FTP server at the destination in compliance with FTP.

[S8] The mail mediating apparatus 151 obtains a destination server, directory, log-in account, and password from a destination list and sets them as an extended header for the mail.

[S9] The mail mediating apparatus 151 transfers the mail proper to the store FTP server in compliance with SMTP.

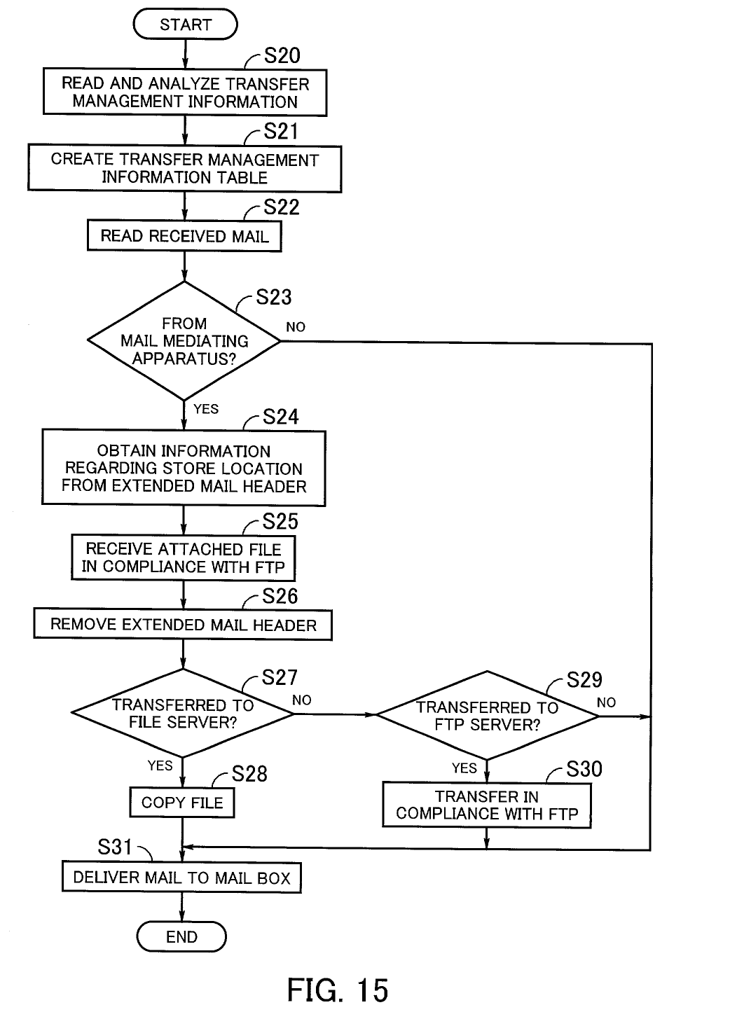

Now, an example of processes performed in the mail mediating apparatus 152 shown in FIG. 2 will be described with reference to FIG. 15. The following procedure will be performed in compliance with this flow chart.

[S20] The mail mediating apparatus 152 reads the transfer management information 103e from the secondary memory 103c and analyzes it.

[S21] The mail mediating apparatus 152 creates a transfer management information table from the transfer management information 103e it read in step S20.

[S22] The mail mediating apparatus 152 reads received mail.

[S23] The mail mediating apparatus 152 judges whether or not the mail was sent from the sender mail mediating apparatus. If it was sent from the sender mail mediating apparatus, the mail mediating apparatus 152 proceeds to step S24. If it was not sent from the sender mail mediating apparatus, the mail mediating apparatus 152 proceeds to step S31.

[S24] The mail mediating apparatus 152 obtains a server and directory where an attached file is stored, a log-in account, and a password from an extended header for the mail.

[S25] The mail mediating apparatus 152 receives the attached file in compliance with FTP and stores it as an intermediate file.

[S26] The mail mediating apparatus 152 removes the extended header from the received mail.

[S27] The mail mediating apparatus 152 judges whether or not the destination of the attached file is a file server. If it is a file server, the mail mediating apparatus 152 proceeds to step S28. If it is not a file server, the mail mediating apparatus 152 proceeds to step S29.

[S28] The mail mediating apparatus 152 copies the attached file to the file server.

[S29] The mail mediating apparatus 152 judges whether or not the destination of the attached file is an FTP server. If it is an FTP server, the mail mediating apparatus 152 proceeds to step S30. If it is not an FTP server, the mail mediating apparatus 152 proceeds to step S31.

[S30] The mail mediating apparatus 152 transfers the attached file to the objective FTP server in compliance with FTP.

[S31] The mail mediating apparatus 152 delivers the mail to a mail box.

By performing the above procedures, the mail mediating apparatus 151 and 152 will be able to fulfill the functions described before.

A second embodiment of the present invention will now be described.

The entire configuration of the second embodiment of the present invention is the same as that of the first embodiment shown in FIG. 2. Moreover, each computer and a data sequence between computers are the same as those in the first embodiment.

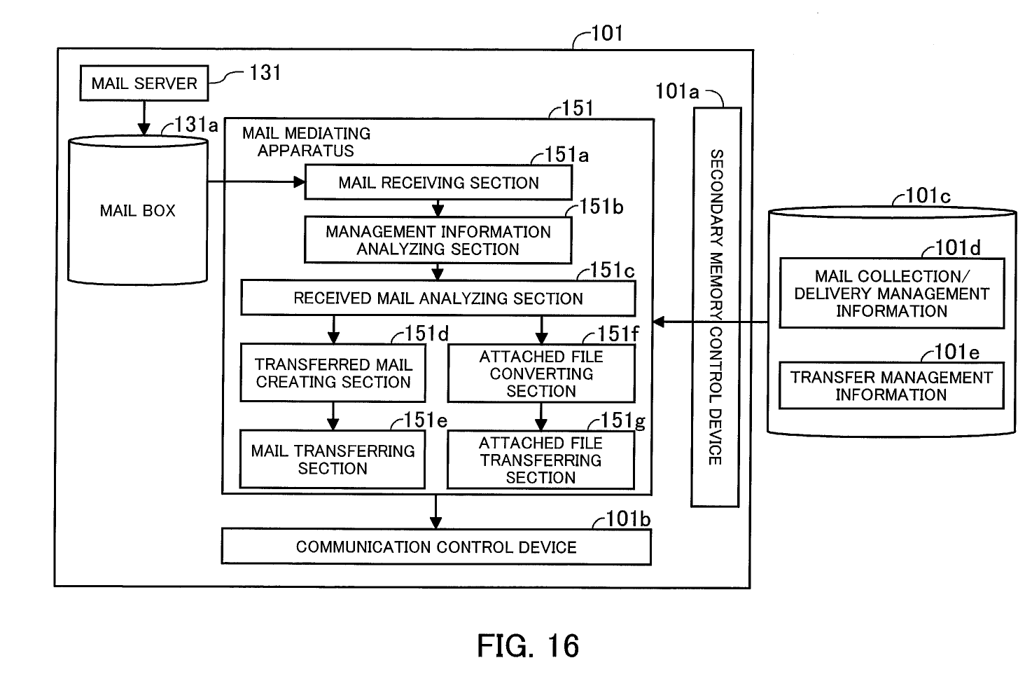

FIG. 16 is a view showing the configuration of the computer 101 in the second embodiment of the present invention. In FIG. 16, sections corresponding to those in FIG. 3 are marked with the same symbols and descriptions of them will be omitted. The configuration of the computer 101 is the same as that in the first embodiment except that the mail receiving section 151a in the mail mediating apparatus 151 receives mail stored in a mail box 131a and directed to the mail mediating apparatus 151.

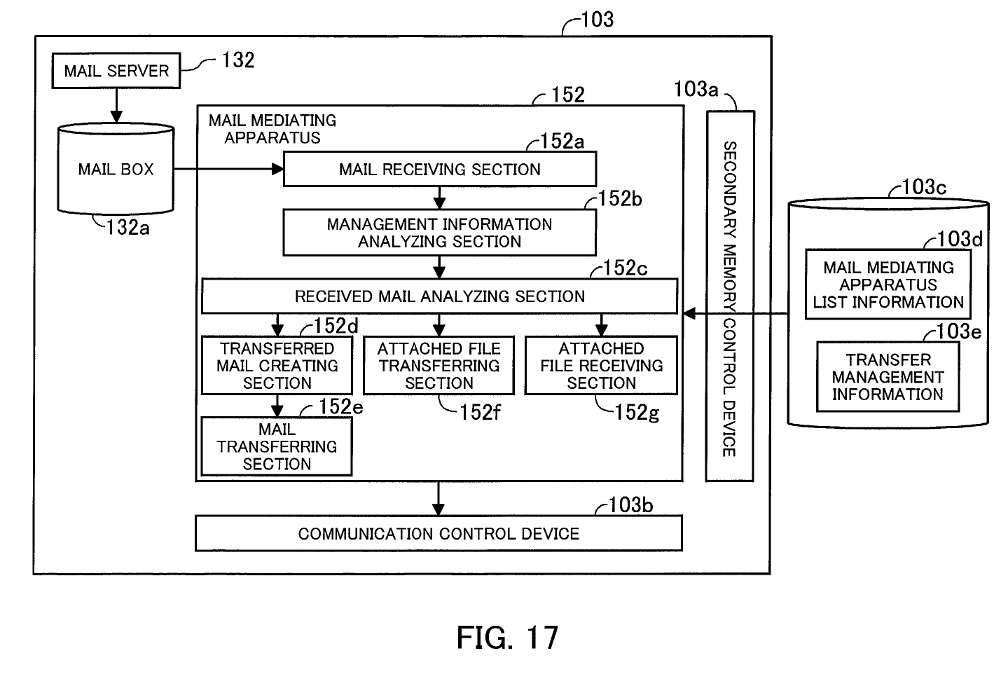

FIG. 17 is a view showing the configuration of the computer 103. In FIG. 17, sections corresponding to those in FIG. 4 are marked with the same symbols and descriptions of them will be omitted. The configuration of the computer 103 is also the same as that in the first embodiment except that the mail receiving section 152a in the mail mediating apparatus 152 receives mail stored in a mail box 132a and directed to the mail mediating apparatus 152.

Now, operation in the second embodiment will be described. It is basically the same with the first embodiment. The differences in operation between the first and second embodiments are as follows.

A mail administrator registers the mail address of the mail mediating apparatus 151 with the mail server 131 before using the system.

With the mail client 141, a user creates mail by attaching a file to an electronic mail body and performs the procedure for sending the electronic mail to the mail address of the mail mediating apparatus 151.

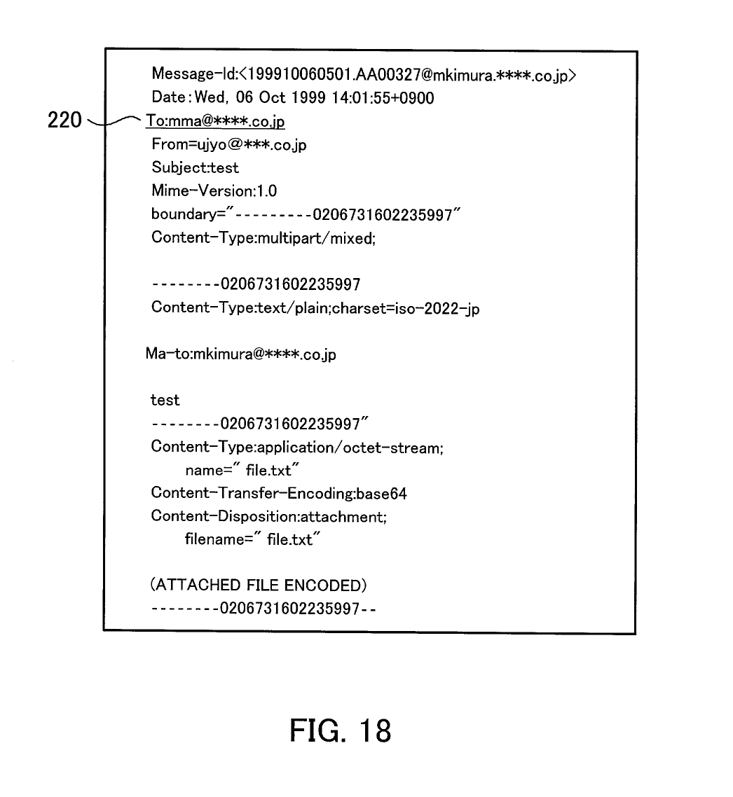

FIG. 18 is a view showing an example of mail created at this time. In this example, “mma@***.co.jp,” being the mail address of the mail mediating apparatus 151, is described as an address to which the mail is sent, as shown in 220.

The mail server 131 stores the mail which it received from the mail client 141 in the mail box 132a shown in FIG. 17.

The mail receiving section 151a in the mail mediating apparatus 151 reads at constant intervals newly received mail which is stored in the mail box 132a. In this example, the mail receiving section 151a reads the mail with an attached file shown in FIG. 18.

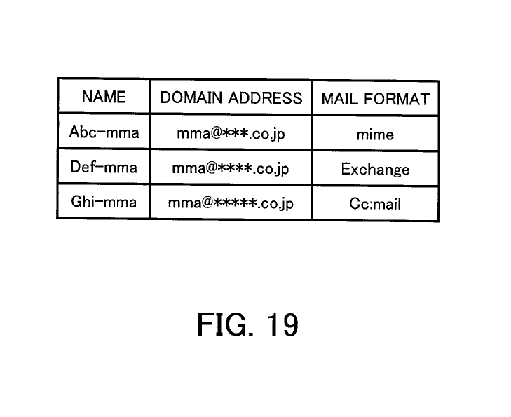

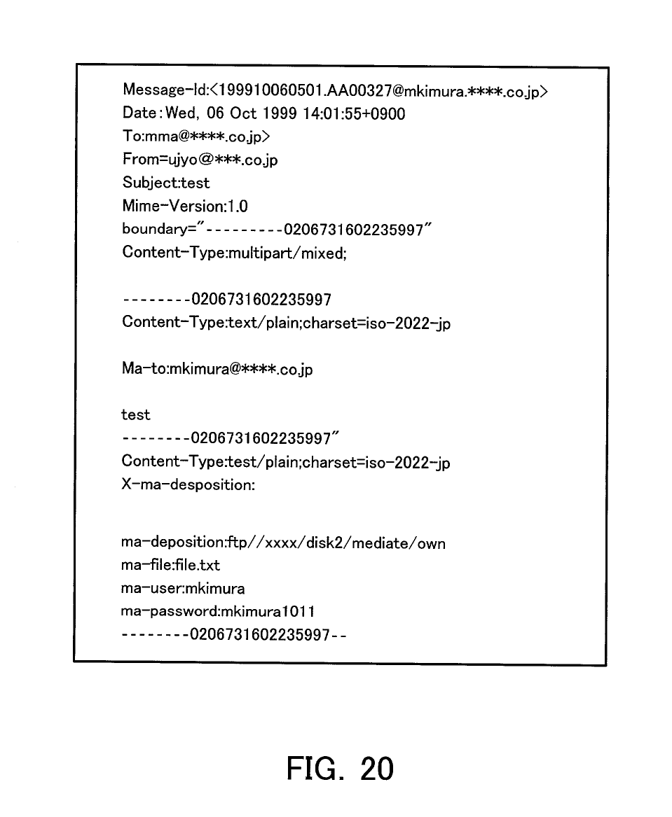

The mail transferring section 151e transfers the mail from which the attached file has been removed to the address of the appropriate mail mediating apparatus on the basis of mail mediating apparatus list information shown in FIG. 19. FIG. 20 shows the state of the mail from which the attached file has been separated. In this example, the attached file added to the end of the text shown in FIG. 18 has been removed.

When the receiver mail server 132 receives this mail, the receiver mail server 132 stores it in the mail box 132a for the mail mediating apparatus 152. The mail receiving section 152a in the mail mediating apparatus 152 reads out new mail from the mail box 132a at constant intervals.

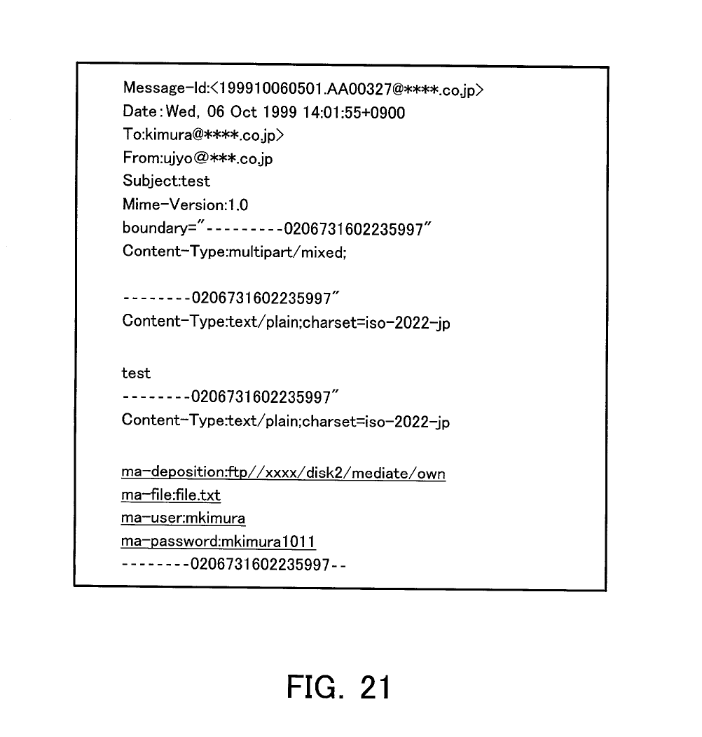

A procedure performed after this is the same as that in the first embodiment. That is to say, mail, for example, shown in FIG. 21 is created and sent to the mail client 142.

In the above embodiment, mail mediating apparatus can be implemented as mail clients connected to sender and receiver mail servers respectively.

A third embodiment of the present invention will now be described. In this embodiment, two mail mediating apparatus are implemented as a proxy server for a receiver mail server and a proxy server for a sender mail server respectively. A system configuration in the third embodiment is the same as that in the first embodiment.

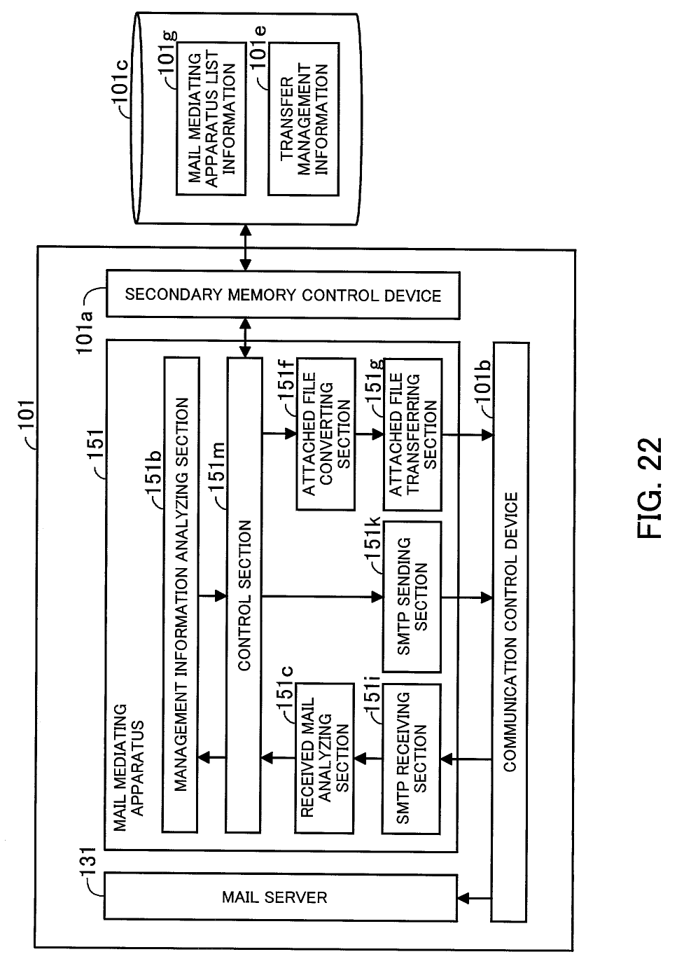

First, the computer 101 will be described in detail with reference to FIG. 22.

As shown in FIG. 22, the computer 101 comprises the mail server 131, the mail mediating apparatus 151, the secondary memory 101c, the secondary memory control device 101a, and the communication control device 101b for controlling the sending of data to or the receiving of data from a network.

The mail mediating apparatus 151 comprises the management information analyzing section 151b, a control section 151m, an SMTP receiving section 151i, the received mail analyzing section 151c, an SMTP sending section 151k, the attached file converting section 151f, and the attached file transferring section 151g.

The SMTP receiving section 151i receives a mail message from the mail client 141. The management information analyzing section 151b analyzes the transfer management information 101e read via the secondary memory control device 101a and stores the results in a temporary memory.

The received mail analyzing section 151c analyzes mail received. If a file is attached to the received mail analyzed, the attached file converting section 151f separates the attached file from the received mail and saves the attached file in the secondary memory 101c as an intermediate file for a time.

The attached file transferring section 151g transfers the attached file separated from the received mail to the FTP server 161 described as a destination in the transfer management information 101e. The SMTP sending section 151k relays the mail message. Furthermore, the SMTP sending section 151k creates information regarding a location where the attached file is stored as a mail message and relays this message to the mail server 131.

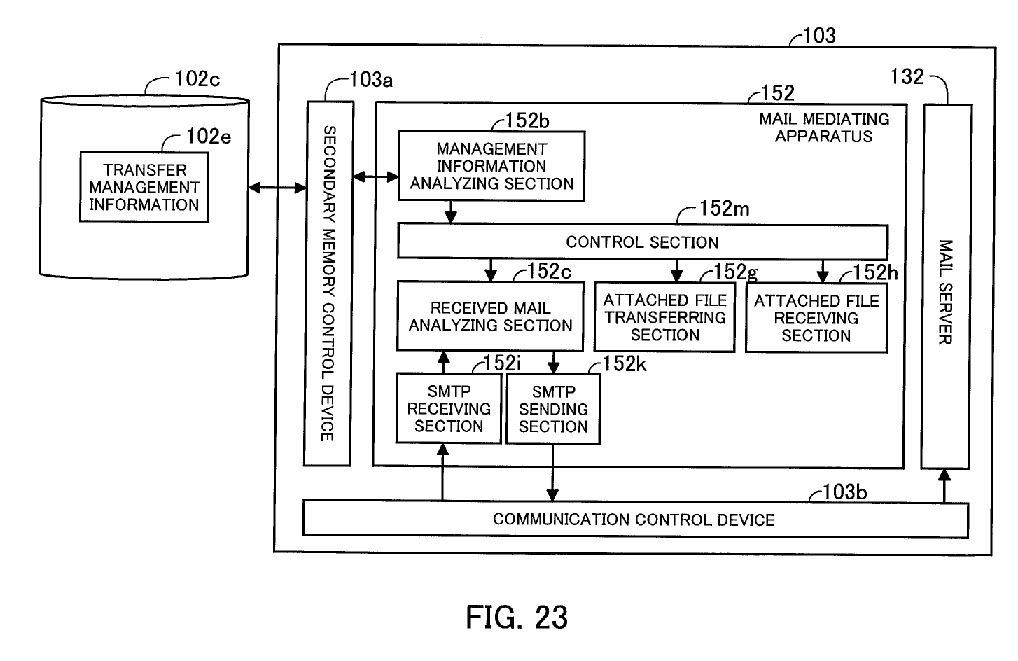

Next, the computer 103 will be described in detail with reference to FIG. 23.

As shown in FIG. 23, the computer 103 comprises the mail server 132, the mail mediating apparatus 152, the secondary memory 102c, the secondary memory control device 103a, and the communication control device 103b.

The mail mediating apparatus 152 comprises the management information analyzing section 152b, a control section 152m, an SMTP receiving section 152i, the received mail analyzing section 152c, an SMTP sending section 152k, the attached file transferring section 152g, and the attached file receiving section 152h.

The SMTP receiving section 152i receives the mail from the mail client 141. The management information analyzing section 152b analyzes the transfer management information 102e read via the secondary memory control device 103a and stores the results in a temporary memory.

The received mail analyzing section 152c analyzes the mail received. The attached file transferring section 152g transfers the attached file separated from the mail to the FTP server 162 described as a destination in the transfer management information 102e stored in the temporary memory. The SMTP sending section 152k relays the mail. Furthermore, the SMTP sending section 152k creates information regarding a location where the attached file is stored as a mail message and relays this message to the mail server 132.

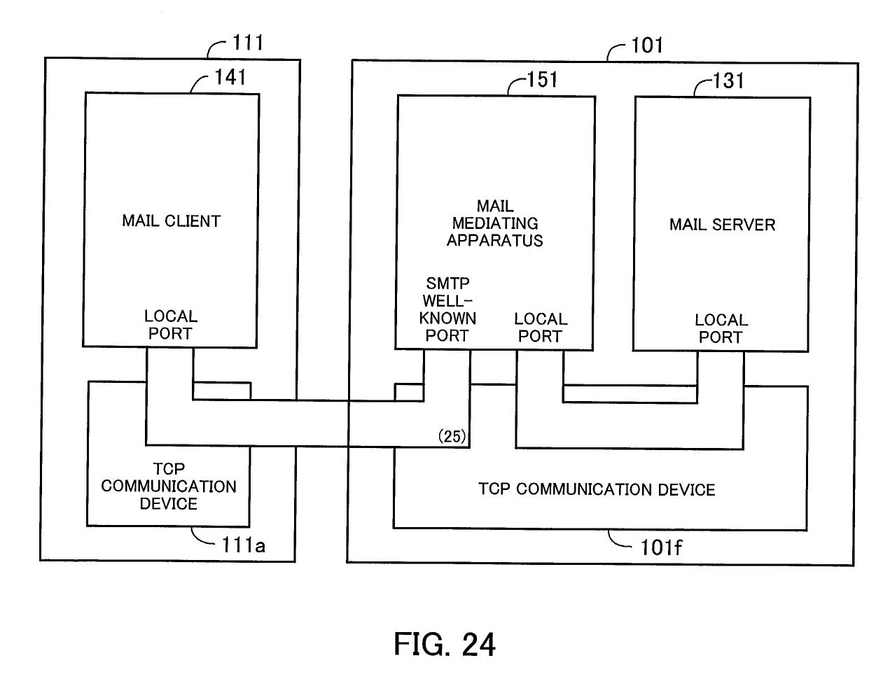

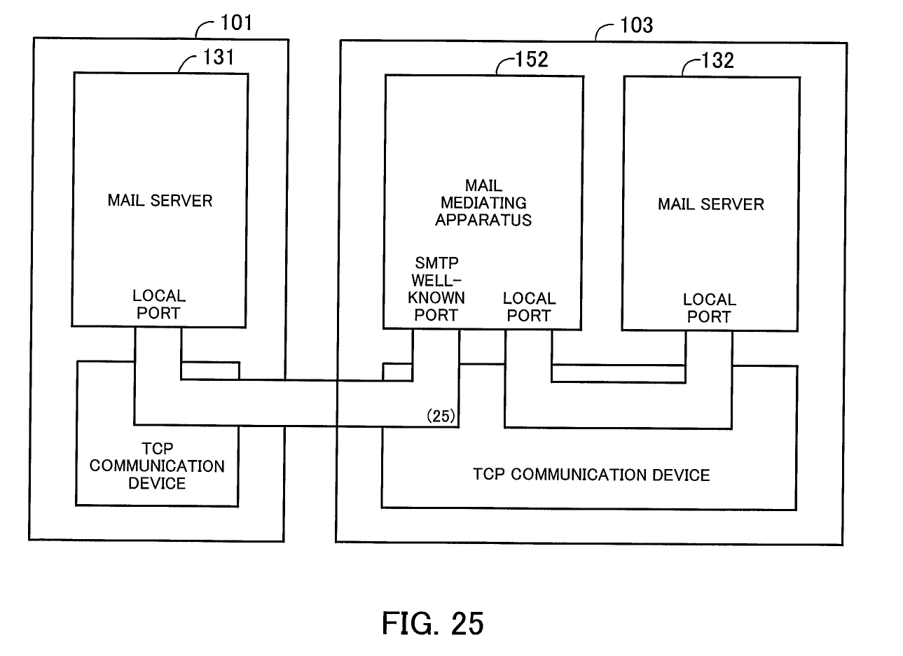

Operation in the above embodiment will now be described. First an overview of the operation of the mail mediating apparatus 151 and 152 will be given with reference to FIGS. 24 and 25, and then the operation in the above embodiment will be described in detail.

FIG. 24 is a view for describing the operation of the mail mediating apparatus 151 as a proxy server. As shown in FIG. 24, in the third embodiment of the present invention, a well-known port (port #25) usually used by the mail server 131 is assigned to the mail mediating apparatus 151 by changing definitions regarding an operating environment for a TCP communication device (the /etc/services file, for example). An unused local port is assigned to the mail server 131.

These changes enable the mail client 141 to send mail to the mail mediating apparatus 151 without changing definitions regarding its operating environment and enable the mail server 131 to receive mail from the mail mediating apparatus 151 with the same definitions regarding its operating environment that are used when the mail server 131 receives mail from the mail client 141.

FIG. 25 is a view for describing the operation of the mail mediating apparatus 152 as a proxy server.

The receiver mail mediating apparatus 152 functions the same as the sender mail mediating apparatus 151 and therefore functions as a proxy server. That is to say, a well-known port (port #25) usually used by the mail server 132 is assigned to the mail mediating apparatus 152 by changing definitions regarding an operating environment for a TCP communication device (the /etc/services file, for example) and an unused local port is assigned to the mail server 132.

The operation in the above embodiment will now be described.

First, the operation of the sender mail mediating apparatus 151 will be described.

The mail mediating apparatus 151 in the computer 101 receives mail sent from the mail client 141 in the computer 111. It is assumed that the mail mediating apparatus 151 conforms to the operation of an Internet electronic mail system (SMTP). The SMTP receiving section 151i in the mail mediating apparatus 151 establishes connection with the mail client 141. Then the SMTP sending section 151k establishes connection with the mail server 131 in the computer 101. The mail client 141 sends, in compliance with SMTP, the mail mediating apparatus 151 a message defined in SMTP that follows the HELO message.

The SMTP receiving section 151i which received the message passes it to the received mail analyzing section 151c. If the received mail is not a DATA message, the received mail analyzing section 151c calls the SMTP sending section 151k and the SMTP sending section 151k relays the message to the mail server 131 in its original condition. Furthermore, the SMTP receiving section 151i receives a response message to this message sent by the mail server 131. The received mail analyzing section 151c which analyzed the message uses the SMTP sending section 151k to relay the message to the mail client 141 in its original condition.

If the received mail is a DATA message and includes character strings indicating that “Content-Type” is “multipart/mixed” and that “Content-Disposition” is “attachment,” a DATA message that follows them is an attached file. The received mail analyzing section 151c therefore calls the attached file converting section 151f.

The attached file converting section 151f converts the attached file encoded to the original binary format and stores the converted file in the secondary memory 101c.

The attached file transferring section 151g called next transfers the attached file stored in the secondary memory 101c to a location designated as a destination on the basis of the transfer management information 101e stored in the temporary memory. In this embodiment, the attached file is transferred to the FTP server 161 by the use of a user account and password included in the transfer management information 101e.

The SMTP sending section 151k called next indicates by sending the mail server 131 the extended mail header “X-ma-deposition” that a DATA message sent next is store information regarding the attached file. Then the SMTP sending section 151k sends store information regarding the attached file.

The mail server 131 creates mail from the messages relayed by the mail mediating apparatus 151 and tries to send it to the mail server 132 in the computer 103 in compliance with the operation of an Internet electronic mail system (SMTP).

Next, the operation of the receiver mail mediating apparatus 152 will be described.

The mail mediating apparatus 152 in the computer 103 receives mail sent from the mail server 131 in the computer 101. The SMTP receiving section 152i in the mail mediating apparatus 152 establishes connection with the mail server 131. Then the SMTP sending section 152k establishes connection with the mail server 132 in the computer 103. The mail server 131 sends, in compliance with SMTP, the mail mediating apparatus 152 a message in SMTP that follows the HELO message.

The SMTP receiving section 152i which received the message passes it to the received mail analyzing section 152c. If the received mail is not a DATA message, the received mail analyzing section 152c calls the SMTP sending section 152k and the SMTP sending section 152k relays the message to the mail server 132 in its original condition.

Furthermore, the SMTP receiving section 152i receives a response message to the message sent by the mail server 131. The received mail analyzing section 152c which analyzed the message uses the SMTP sending section 152k to relay the message to the mail server 132 in its original condition.

If the received mail is a DATA message and went through the mail mediating apparatus 151 (the extended header “X-ma-deposition:” exists), the attached file receiving section 152h receives an attached file from the FTP server 161 by the use of a store server name, store directory, user account, and password, being store information regarding the attached file, included in a DATA message sent next and stores it in the secondary memory 102c for a time.

If the received mail did not go through the mail mediating apparatus 151 (if the extended header “X-madeposition:” does not exist), the message is transferred to the mail mediating apparatus 152.

The received mail analyzing section 152c performs the same process that the received mail analyzing section 151c in the sender mail mediating apparatus 151 performs. That is to say, the received mail analyzing section 152c converts the attached file to the original binary format and stores the converted file in the secondary memory 102c. Furthermore, the received mail analyzing section 152c sends the mail server 132 mail store information, which is based on transfer management information stored in a memory, as a DATA message instead of messages comprising the attached file received.

The attached file transferring section 152g called next transfers the attached file stored in the secondary memory 102c in this way to the FTP server 162 designated in store location information on the basis of the transfer management information stored in the temporary memory.

The mail server 132 creates mail from these messages relayed (see FIG. 12). Furthermore, the mail server 132 delivers the received mail to the original destination mail box. This mail delivery process is the same as a local delivery process performed by an ordinary mail server on Internet. The mail client 142 in the computer 112 receives the mail without the attached file delivered to the mail box on the mail server 132 in this way. A mail user can obtain a store server, store directory, log-in account, and password, which are included in the transfer management information, from the mail body as store location information. He/she therefore can refer to the attached file by accessing the FTP server 162 on the basis of these pieces of information.

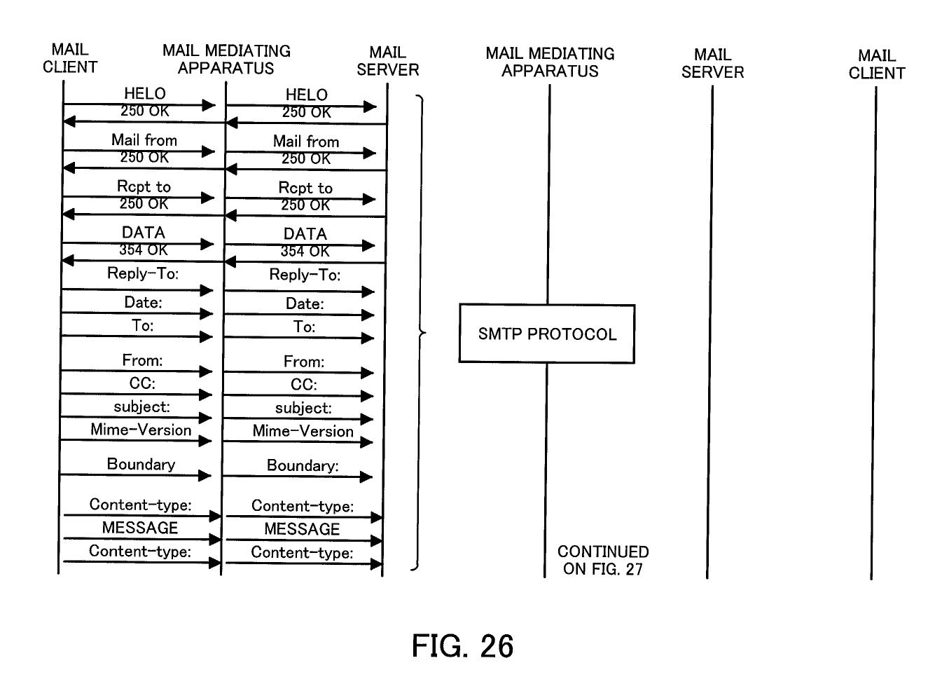

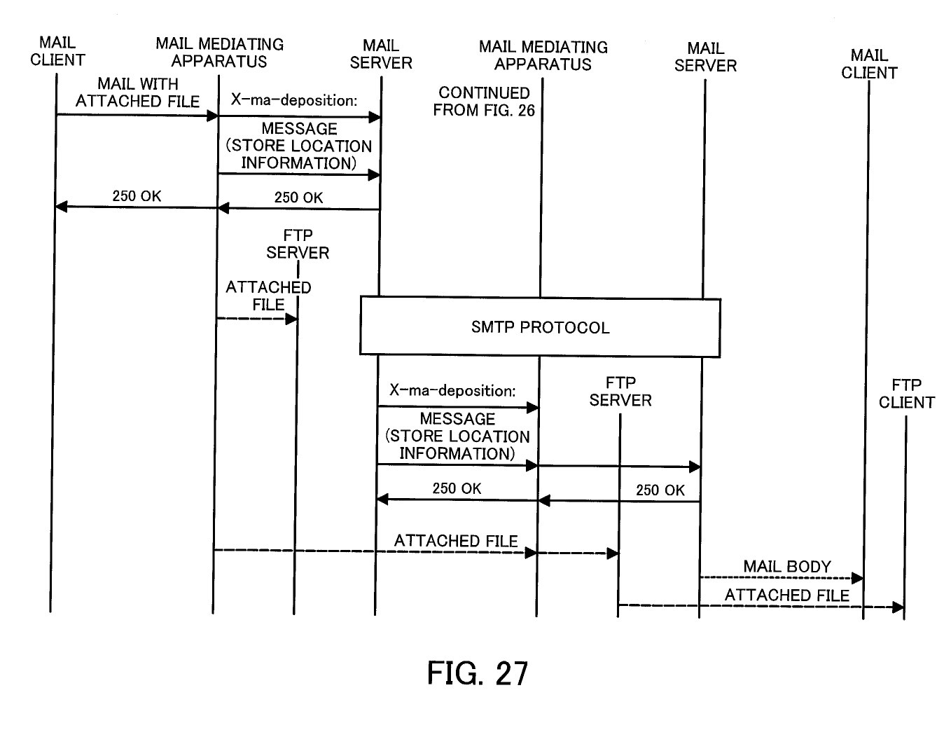

Now, a data sequence between the computers in the above embodiment will be described with reference to FIGS. 26 and 27.

The mail client 141 in the computer 111 sends mail with an attached file to the mail mediating apparatus 151 in the computer 101. Message communication between them conforms to the Internet electronic mail protocol (SMTP).

As shown in FIG. 26, the mail mediating apparatus 151 which received mail data sent in compliance with SMTP (SMTP message) relays it to the mail server 131.

As shown in FIG. 27, the mail mediating apparatus 151 which received the SMTP message sends the attached file to the FTP server 161 in the computer 102. Moreover, the mail mediating apparatus 151 sends the mail server 131 an extended mail header as messages. At the same time, the mail mediating apparatus 151 adds store location information regarding the attached file to the mail body, and then sends the server 131 the store location information as messages.

The mail server 131 sends the mail mediating apparatus 152 in the computer 103 the extended mail header and the maul body to which the store location information has been added. The mail mediating apparatus 152 that received the mail body relays it to the mail server 132.

Further, on the basis of the extended mail header, the mail mediating apparatus 152 knows from the store location information regarding the attached file in the mail body that the attached file is stored on the FTP server 161 in the computer 102. Then the mail mediating apparatus 152 receives the attached file from the FTP server 161.

Furthermore, the mail mediating apparatus 152 transfers the attached file it received to the FTP server 162 in the computer 104.

In addition, the mail server 132 sends the mail body to the mail client 142 in the computer 112.

Note that, a user can read the attached file stored in the FTP server 162 by referring to the store location information added to the mail body.

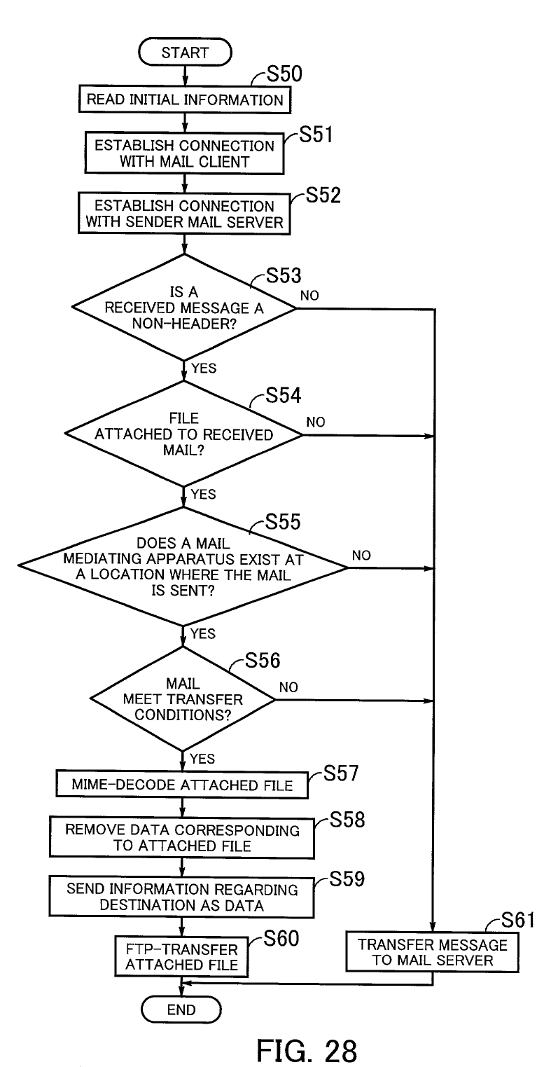

An example of processes performed in the mail mediating apparatus 151 in the third embodiment will now be described with reference to FIG. 28. The following procedure will be performed in compliance with this flow chart.

[S50] The mail mediating apparatus 151 reads the mail mediating apparatus list information 101g and transfer management information 101e as initial information, analyzes them, and creates a mail mediating apparatus list information table and transfer management information table.

[S51] The mail mediating apparatus 151 establishes connection with the mail client 141.

[S52] The mail mediating apparatus 151 establishes connection with the sender mail server 131.

[S53] The mail mediating apparatus 151 judges whether or not a message it received is a header. If the message is not a header, the mail mediating apparatus 151 proceeds to step S54. If the message is a header, the mail mediating apparatus 151 proceeds to step S61.

[S54] The mail mediating apparatus 151 judges whether or not a file is attached to mail it received. If it is attached, the mail mediating apparatus 151 proceeds to step S55. If it is not attached, the mail mediating apparatus 151 proceeds to step S61.

[S55] The mail mediating apparatus 151 judges whether or not a mail mediating apparatus exists at a location where the mail is sent. If a mail mediating apparatus exists, the mail mediating apparatus 151 proceeds to step S56. If a mail mediating apparatus does not exist, the mail mediating apparatus 151 proceeds to step S61.

[S56] The mail mediating apparatus 151 judges whether or not the mail meets transfer conditions. If it meets the transfer conditions, the mail mediating apparatus 151 proceeds to step S57. If it does not meet the transfer conditions, the mail mediating apparatus 151 proceeds to step S61.

[S57] The mail mediating apparatus 151 MIME-decodes the attached file and saves a file obtained in the secondary memory 101c.

[S58] The mail mediating apparatus 151 removes data corresponding to the attached file.

[S59] The mail mediating apparatus 151 sends a destination server, directory, log-in account, and password included in a destination list to the mail server 131 as data.

[S60] The mail mediating apparatus 151 transfers the attached file in compliance with FTP.

[S61] The mail mediating apparatus 151 transfers the message to the mail server 131.

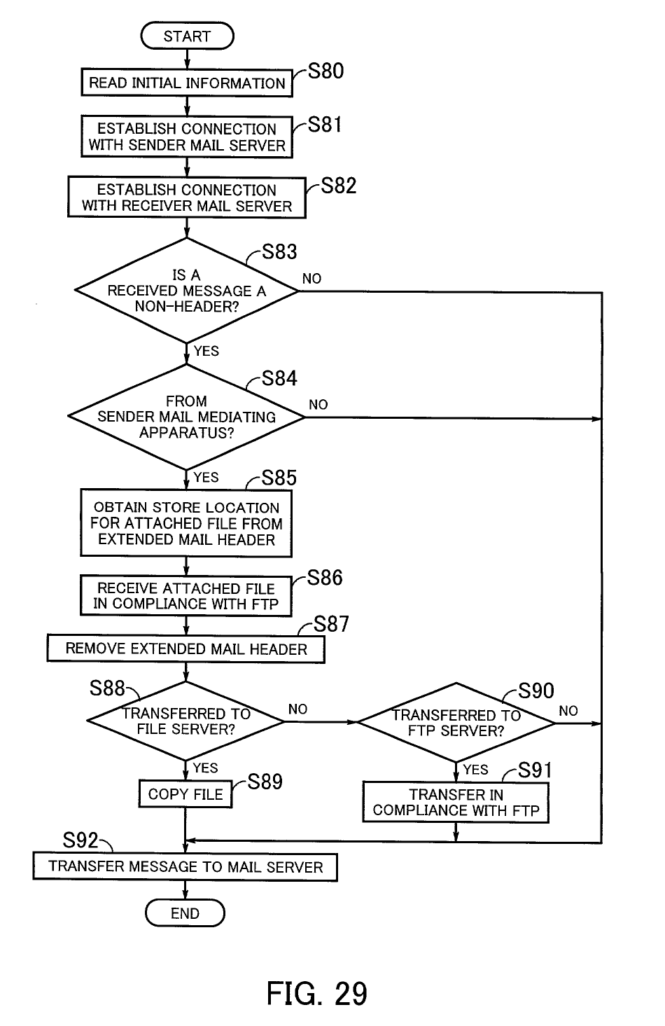

An example of processes performed in the mail mediating apparatus 152 will now be described with reference to FIG. 29. The following procedure will be performed in compliance with this flow chart.

[S80] The mail mediating apparatus 152 reads and analyzes the transfer management information 102e as initial information and creates a transfer management information table.

[S81] The mail mediating apparatus 152 establishes connection with the sender mail server 131.

[S82] The mail mediating apparatus 152 establishes connection with the receiver mail server 132.

[S83] The mail mediating apparatus 152 judges whether or not mail it received is a header. If the mail is not a header, the mail mediating apparatus 152 proceeds to step S84. If the mail is a header, the mail mediating apparatus 152 proceeds to step S92.

[S84] The mail mediating apparatus 152 judges whether or not the mail was sent from the sender mail mediating apparatus 151. If it was sent from the sender mail mediating apparatus 151, the mail mediating apparatus 152 proceeds to step S85. If it was not sent from the sender mail mediating apparatus 151, the mail mediating apparatus 152 proceeds to step S92.

[S85] The mail mediating apparatus 152 refers to an extended header for the mail and obtains a server and directory where an attached file is stored, a log-in account, and a password from it.

[S86] The mail mediating apparatus 152 receives the attached file in compliance with FTP and stores it in the secondary memory 102c as an intermediate file.

[S87] The mail mediating apparatus 152 removes the extended mail header information from the mail it received.

[S88] The mail mediating apparatus 152 judges whether or not the destination of the attached file is a file server. If it is a file server, the mail mediating apparatus 152 proceeds to step S89. If it is not a file server, the mail mediating apparatus 152 proceeds to step S90.

[S89] The mail mediating apparatus 152 copies the attached file to the file server.

[S90] The mail mediating apparatus 152 judges whether or not the destination of the attached file is an FTP server. If it is an FTP server, the mail mediating apparatus 152 proceeds to step S91. If it is not an FTP server, the mail mediating apparatus 152 proceeds to step S92.

[S91] The mail mediating apparatus 152 transfers the attached file to the FTP server in compliance with FTP.

[S92] The mail mediating apparatus 152 transfers the message to the mail server 132.

The functions shown in the third embodiment can be realized by the above procedure.

Now, a fourth embodiment of the present invention will be described. In the fourth embodiment of the present invention, two mail mediating apparatuses are used as a proxy server for a receiver mail server and a proxy server for a relay mail server respectively.

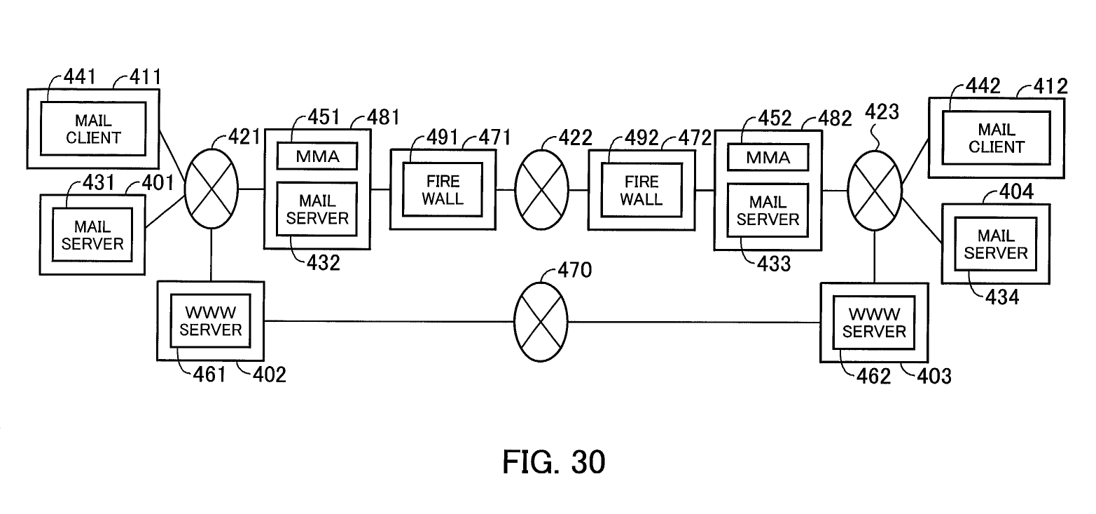

FIG. 30 is a view showing the entire configuration of a system according to the fourth embodiment of the present invention.

As shown in FIG. 30, computers 401, 402, 411, and 481 are connected to one another via LAN 421. A computer 471 is connected to the computer 481 and Internet 422. A computer 472 is connected to the Internet 422 and a computer 482. Computers 403, 404, and 412 and the computer 482 are connected to LAN 423. The computers 402 and 403 are connected via a wide area network (WAN) 470.

A mail server 432 and mail mediating apparatus 451 are mounted in the computer 481. A mail server 433 and mail mediating apparatus 452 are mounted in the computer 482. World wide web (WWW) servers 461 and 462 are mounted in the computers 402 and 403 respectively. Mail clients 441 and 442 are mounted in the computers 411 and 412 respectively.

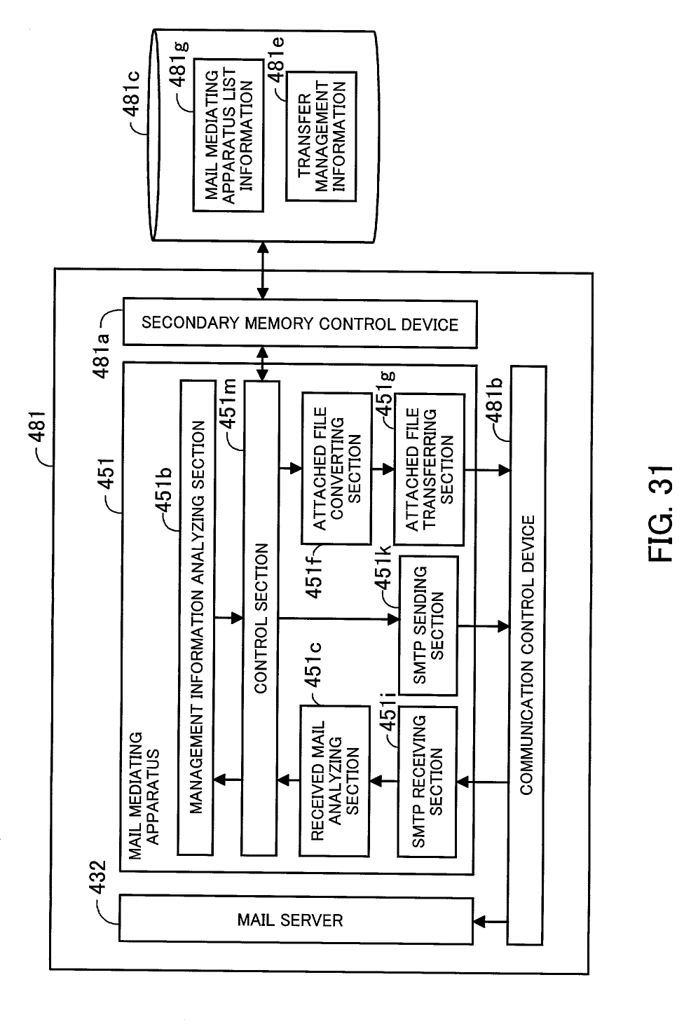

FIG. 31 is a view showing in detail the configuration of the computer 481. The configuration of the computer 482 is the same as that of the computer 481. Descriptions will now be given with the computer 481 as an example.

As shown in FIG. 31, the computer 481 comprises the mail server 432 for receiving mail from the mail mediating apparatus 451 in compliance with the SMTP protocol, the mail mediating apparatus 451 for receiving mail from the mail client 441 in compliance with the SMTP protocol, a secondary memory 481c for holding transfer management information 481e and mail mediating apparatus list information 481g, a secondary memory control device 481a for controlling the secondary memory 481c, and a communication control device 481b for controlling the sending of data to or the receiving of data from a network.

The mail mediating apparatus 451 comprises a management information analyzing section 451b, a control section 451m, an SMTP receiving section 451i, a received mail analyzing section 451c, an SMTP sending section 451k, an attached file converting section 451f, and an attached file transferring section 451g.

The SMTP receiving section 451i receives a mail message from the mail client 441. The management information analyzing section 451b analyzes the transfer management information 481e read via the secondary memory control device 481a and stores the results in a temporary memory.

The received mail analyzing section 451c analyzes the mail received. If a file is attached to the received mail analyzed, the attached file converting section 451f separates the attached file from the received mail and saves the attached file in the secondary memory 481c as an intermediate file for a time.

The attached file transferring section 451g transfers the attached file separated from the received mail to the WWW server 461 described as a destination in the transfer management information 481e stored in the temporary memory. The SMTP sending section 451k relays the mail message. Furthermore, the SMTP sending section 451k creates information regarding a location where the attached file is stored as a mail message and relays this message to the mail server 432.

Now, operation in the above embodiment will be described.

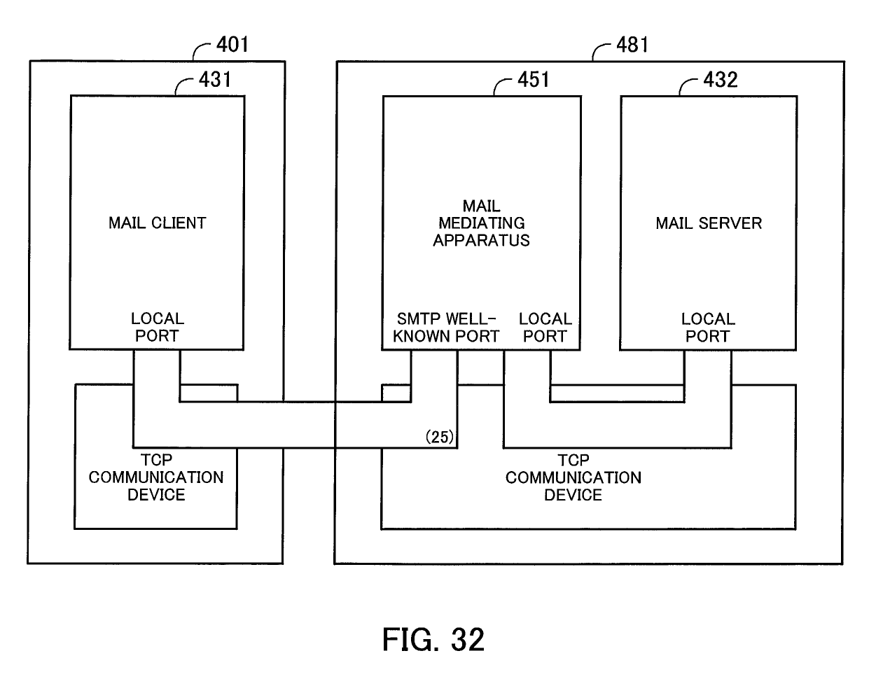

FIG. 32 shows the operating principle of the mail mediating apparatus 451. This operating principle is the same as that of the mail mediating apparatus 151 as a proxy server shown in FIG. 24 except that a mail server 431 relays mail with an attached file to the mail mediating apparatus 451.

Operation performed when mail with an attached file is sent from the mail client 441 to the mail client 442 will now be described.

Mail sent from the mail client 441 in the computers 411 is received by the mail mediating apparatus 451 in the computer 481 via the mail server 431 in the computer 401. It is assumed that the mail mediating apparatus 451 conforms to SMTP. The SMTP receiving section 451i in the mail mediating apparatus 451 establishes connection with the mail server 431 in the computer 401 and receives a message in compliance with SMTP.

The SMTP receiving section 451i which received the message passes it to the received mail analyzing section 451c. If the received message is not a DATA message, the received mail analyzing section 451c calls the SMTP sending section 451k and the SMTP sending section 451k passes the message to the mail server 432 in its original condition.

If the received message is a DATA message and includes character strings indicating that “Content-Type” is “multipart/mixed” and that “Content-Disposition” is “attachment,” a DATA message that follows them is an attached file. The received mail analyzing section 451c therefore calls the attached file converting section 451f.

The attached file converting section 451f converts the attached file MIME-encoded to the original binary format and stores the converted file in the secondary memory 481c.

The attached file transferring section 451g called next transfers the attached file stored in the secondary memory 481c to a location designated as a destination on the basis of the transfer management information 481e stored in the memory. In this embodiment, the attached file is transferred to the WWW server 461 in the computer 402 by the use of a user account and password included in the transfer management information 481e.

The SMTP sending section 451k called next informs the mail server 432 by sending it the extended mail header “X-ma-deposition” that a DATA message sent next is store information regarding the attached file. Then the SMTP sending section 451k sends store information regarding the attached file.

The mail server 432 creates mail from the messages relayed by the mail mediating apparatus 451 and sends it to the mail server 433 in the computer 482 in compliance with SMTP.

The mail mediating apparatus 452 in the computer 482 receives mail sent from the mail server 432 in the computer 481 via the computer 472. An SMTP receiving section in the mail mediating apparatus 452 establishes connection with the mail server 432. Then an SMTP sending section establishes connection with the mail server 433. The mail server 432 sends the mail mediating apparatus 452 a message in compliance with SMTP.

The SMTP receiving section in the mail mediating apparatus 452 which received the message passes it to a received mail analyzing section. If the received message is not a DATA message, the received mail analyzing section calls the SMTP sending section and the SMTP sending section relays the message to the mail server 433 in its original condition.

Furthermore, the SMTP receiving section receives a response message to the message sent by the mail server 432. The received mail analyzing section which analyzed the message uses the SMTP sending section to relay the message to the mail server 432 in its original condition.

If the received message is a DATA message and went through the mail mediating apparatus 451 (the extended header “X-ma-deposition” exists), an attached file receiving section receives an attached file from the WWW server 461, being a location where it is stored, via the network 470 by the use of a store server name, store directory name, user account, and password, being store information regarding the attached file, included in a DATA message sent next and stores it in a secondary memory in the computer 482.

If the received mail did not go through the mail mediating apparatus 451, the message is transferred to the mail server 433.

Then the received mail analyzing section and an attached file converting section in the mail mediating apparatus 452 perform the same processes that have been described above. That is to say, the attached file is converted to the original binary format and is stored in the secondary memory. Furthermore, store information regarding the attached file, which is based on transfer management information stored in a memory, is sent to the mail server 433 as a DATA message instead of messages comprising the attached file received.

An attached file transferring section called next transfers the attached file stored in the secondary memory to the WWW server 462 designated in store location information on the basis of the transfer management information stored in the memory.

The mail server 433 creates mail from these messages relayed and sends it to the mail server 434 at a location where the mail is sent. The mail client 442 in the computer 412 receives the mail without the attached file stored in a mail box on the mail server 434 in the computer 404 in this way.

A user of the computer 412 can receive this mail by accessing the mail server 434. A store server, store directory, log-in account, and password, which are included in the transfer management information, are added to the mail body as store location information. By referring to these pieces of information, therefore, he/she can obtain the attached file from the WWW server 462 and refer to it.

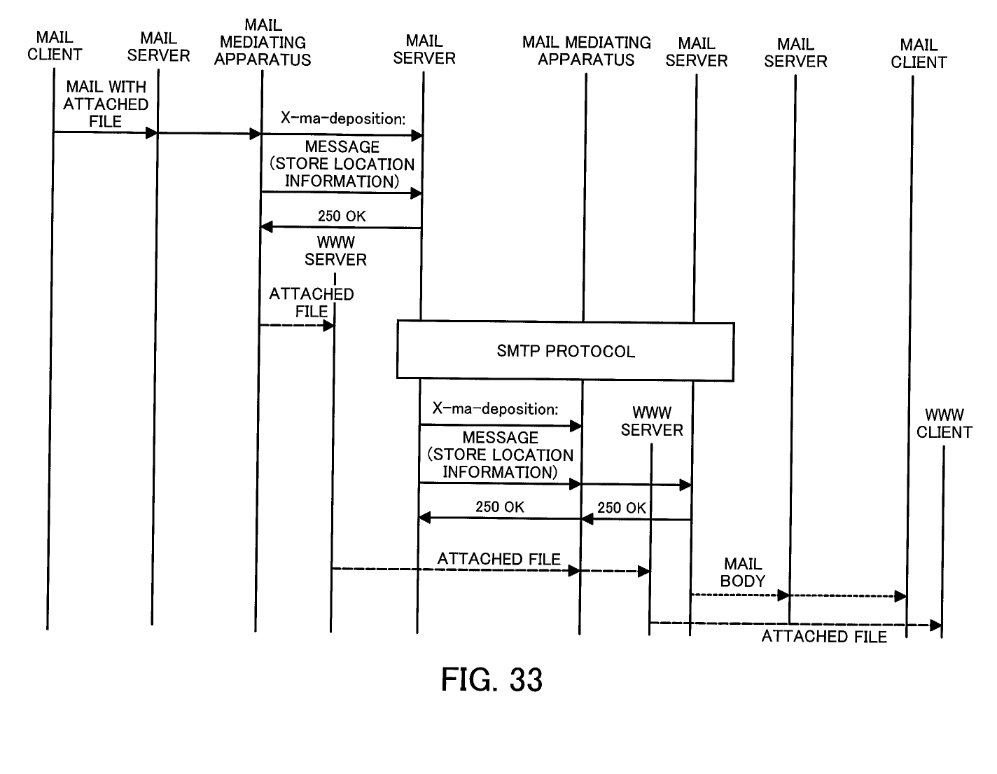

FIG. 33 shows a signal flow for describing the flow of signals regarding the above operation. As shown in FIG. 33, mail with an attached file sent from the mail client 441 is passed to the mail mediating apparatus 451 via the mail server 431. The mail mediating apparatus 451 passes the extended mail header “X-ma-deposition” to the mail server 432 and then passes store location information to the mail server 432 as a message. The attached file is transferred to the WWW server 461.

The mail server 432 passes the message passed to it to the mail mediating apparatus 452. The mail mediating apparatus 452 which received the message creates mail on the basis of this message and sends it to the mail server 433 in compliance with SMTP.

The mail server 433 sends the mail it received to the mail server 434, being a destination. Then, the mail mediating apparatus 452 obtains the attached file from the WWW server 461 by referring to the message.

On the other hand, the attached file is transferred to the WWW server 462 by the mail mediating apparatus 452 and is stored on it.

When a user of the mail client 442 accesses the mail server 434, he/she will receive this mail. By referring to the store location information added to this mail, he/she can download the attached file from the WWW server 462 and read its contents with a WWW client.

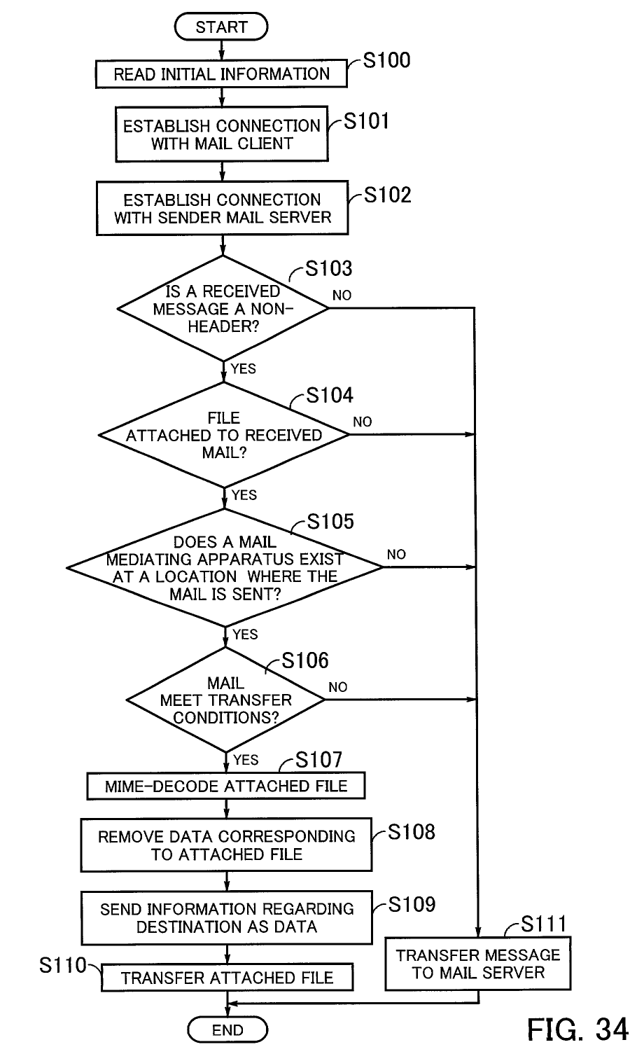

Now, an example of processes performed in the mail mediating apparatus 451 will be described with reference to FIG. 34. The following procedure will be performed in compliance with this flow chart.

[S100] The mail mediating apparatus 451 reads the mail mediating apparatus list information 481g and transfer management information 481e as initial information, analyzes them, and creates a mail mediating apparatus list information table and transfer management information table.

[S101] The mail mediating apparatus 451 establishes connection with the mail client 441.

[S102] The mail mediating apparatus 451 establishes connection with the sender mail server 431.

[S103] The mail mediating apparatus 451 judges whether or not a message it received is a header. If the message is not a header, the mail mediating apparatus 451 proceeds to step S104. If the message is a header, the mail mediating apparatus 451 proceeds to step S111.

[S104] The mail mediating apparatus 451 judges whether or not a file is attached to mail it received. If it is attached, the mail mediating apparatus 451 proceeds to step S105. If it is not attached, the mail mediating apparatus 451 proceeds to step S111.

[S105] The mail mediating apparatus 451 judges whether or not a mail mediating apparatus exists at a location where the mail is sent. If a mail mediating apparatus exists, the mail mediating apparatus 451 proceeds to step S106. If a mail mediating apparatus does not exist, the mail mediating apparatus 451 proceeds to step S111.

[S106] The mail mediating apparatus 451 judges whether or not the mail meets transfer conditions. If it meets the transfer conditions, the mail mediating apparatus 451 proceeds to step S107. If it does not meet the transfer conditions, the mail mediating apparatus 451 proceeds to step S111.

[S107] The mail mediating apparatus 451 MIME-decodes the attached file and saves a file obtained in the secondary memory 481c.

[S108] The mail mediating apparatus 451 removes data corresponding to the attached file.

[S109] The mail mediating apparatus 451 sends a destination server, directory, log-in account, and password included in a destination list to the mail server 432 as data.

[S110] The mail mediating apparatus 451 transfers the attached file in compliance with FTP.

[S111] The mail mediating apparatus 451 transfers the message to the mail server 432.

The functions of the mail mediating apparatus 451 shown in the fourth embodiment can be realized by the above procedure.

Finally an embodiment in which a secondary memory is implemented by the lightweight directory protocol (LDAP) and an embodiment in which a secondary memory is implemented by open database connectivity (ODBC) will be described.

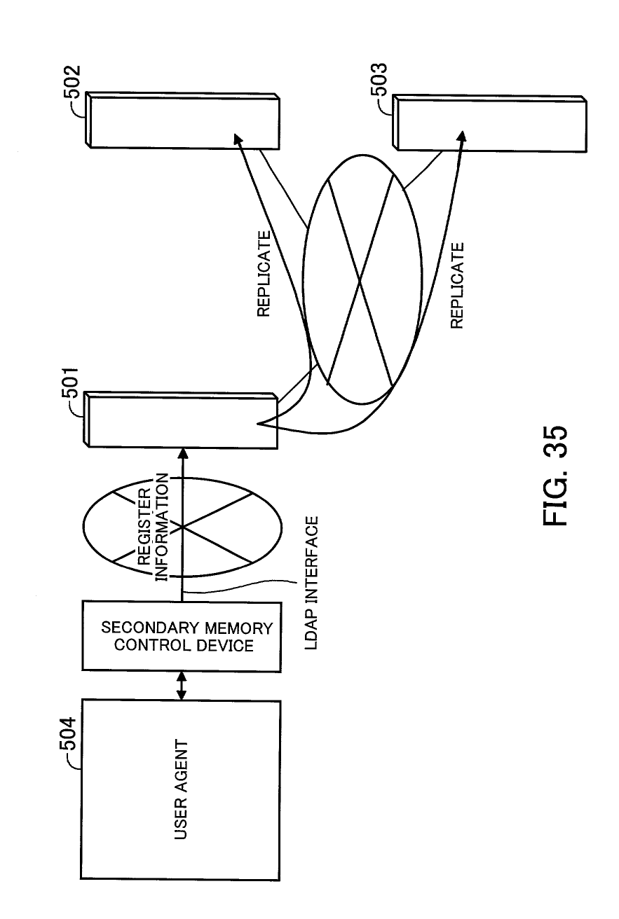

First, an embodiment in which two mail mediating apparatus are used as a proxy server for a receiver mail server and a proxy server for a relay mail server respectively will be described. FIG. 35 is a view for giving an overview of an embodiment in which transfer management information is registered with an LDAP server. A user agent 504 registers information with an LDAP server 501 via a network. The information registered with the LDAP server 501 is replicated on LDAP servers 502 and 503.

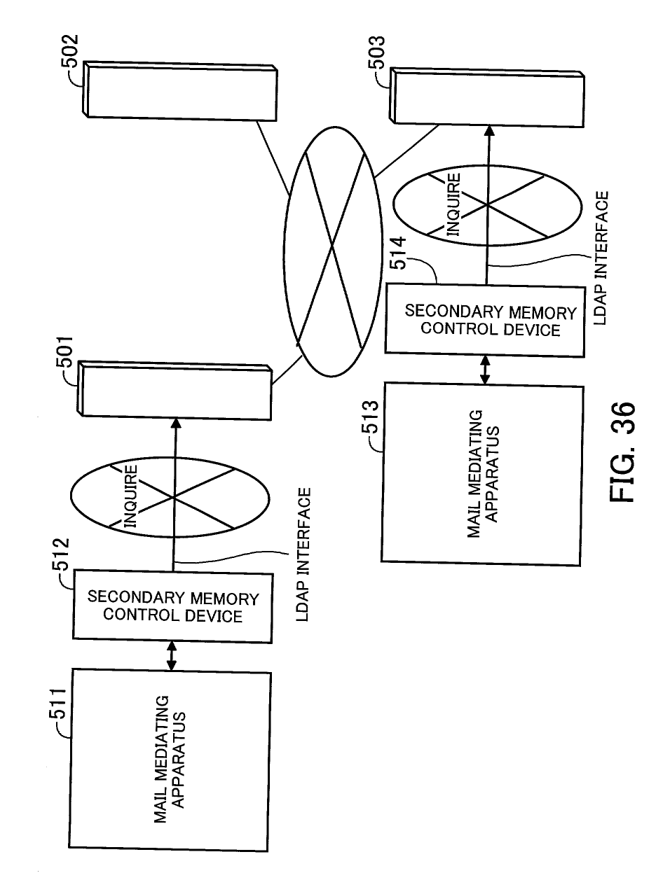

FIG. 36 is a view for giving an overview of operation to refer to transfer management information stored on an LDAP server. Mail mediating apparatuses 511 and 513 make inquiries by the use of LDAP interfaces at the LDAP servers 501 and 503 via secondary memory control devices 512 and 514 respectively and obtain transfer management information.

Next, an embodiment in which two mail mediating apparatuses are used as a proxy server for a receiver mail server and a proxy server for a relay mail server respectively will be described.

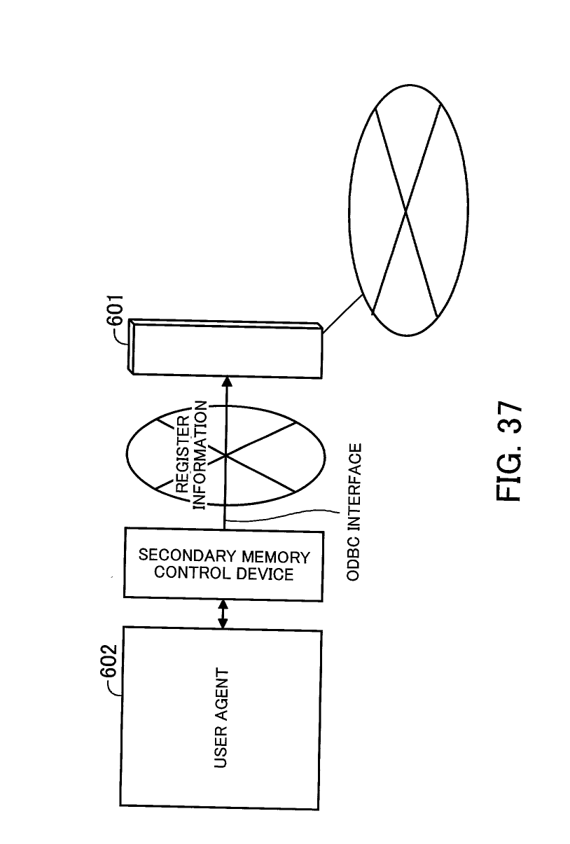

FIG. 37 is a view showing an embodiment in which transfer management information is registered with a database server by the use of an ODBC interface. A user agent 602 registers information with a database server 601 via a network by the use of an ODBC interface.

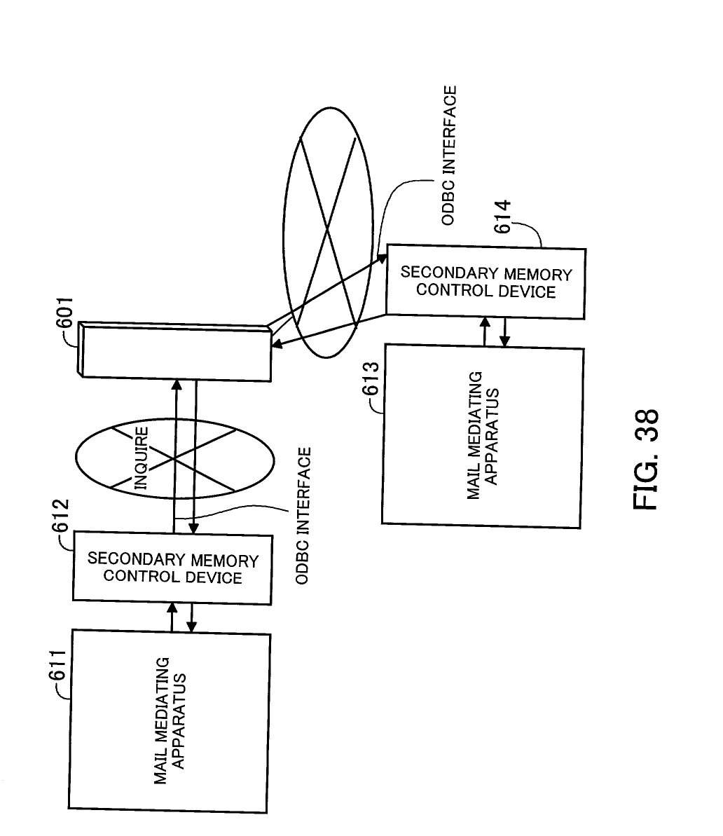

FIG. 38 is a view for giving an overview of operation to refer to transfer management information stored on a database server by the use of an ODBC interface. Mail mediating apparatuses 611 and 613 make inquiries at the database server 601 by the use of ODBC interfaces via secondary memory control devices 612 and 614 respectively and obtain transfer management information.

In the above embodiments, a secondary memory can be configured by LDAP or ODBC.

Finally the above functions can be realized with a computer. In that case, the contents of functions which a mail mediating apparatus must have are described in a program recorded on a record medium which can be read with a computer. The above procedure is achieved with a computer by executing this program on the computer. A record medium which can be read with a computer can be a magnetic recording medium, a semiconductor memory, or the like. In order to place this program on the market, it can be stored on a portable record medium, such as a compact disk read only memory (CD-ROM) or a floppy disk. Alternatively, it can be stored in a memory of a computer connected via a network and be transferred to another computer via a network. When this program is executed on a computer, it is stored on a hard disk etc. in the computer and is loaded into a main memory.

As described above, an electronic mail system for delivering electronic mail sent from a sender to the appropriate receiver according to the present invention comprises attached file separating means for separating, in the case of an attached file being added to electronic mail sent from the sender, the attached file from the electronic mail, attached file transferring means for transferring the attached file separated from the electronic mail by the attached file separating means to a predetermined server, and store location information adding means for adding store location information indicating a location where the attached file transferred by the attached file transferring means is stored to the electronic mail. This enables mail with an attached file to be delivered reliably regardless of the status of intermediate mail servers when it is transferred via Internet.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. An electronic mail system for delivering electronic mail sent from a sender to the appropriate receiver, the system comprising:
attached file separating means for separating, in the case of an attached file being added to electronic mail sent from the sender, the attached file from the electronic mail;
attached file transferring means for transferring the attached file separated from the electronic mail by the attached file separating means to a predetermined server; and
store location information adding means for adding store location information indicating a location where the attached file transferred by the attached file transferring means is stored to the electronic mail.

2. The electronic mail system according to claim 1, further comprising transfer method setting means for setting a transfer method used by the attached file transferring means according to the attribute of an attached file.

3. The electronic mail system according to claim 1, wherein not only store location information but also transfer method information indicating a transfer method used by the attached file transferring means are added to the electronic mail.

4. The electronic mail system according to claim 1, wherein the attached file separating means, attached file transferring means, and store location information adding means are implemented as exit programs on an electronic mail server.

5. A computer-readable record medium recording a computer program for realizing the functions of an electronic mail server for delivering electronic mail sent from a sender to the appropriate receiver, the program comprising the functions of:
attached file separating means for separating, in the case of an attached file being added to electronic mail sent from the sender, the attached file from the electronic mail;
attached file transferring means for transferring the attached file separated from the electronic mail by the attached file separating means to a predetermined server; and
store location information adding means for adding store location information indicating a location where the attached file transferred by the attached file transferring means is stored to the electronic mail.

6. An electronic mail delivery method for delivering electronic mail sent from a sender to the appropriate receiver, the system comprising:
an attached file separating step for separating, in the case of an attached file being added to electronic mail sent from the sender, the attached file from the electronic mail;
an attached file transferring step for transferring the attached file separated from the electronic mail by the attached file separating step to a predetermined server; and
a store location information adding step for adding store location information indicating a location where the attached file transferred by the attached file transferring step is stored to the electronic mail.
